(19) United States
(12) Patent Application Publication
(10) Pub. No.: US 2015/0344666 A1
(43) Pub. Date: Dec. 3, 2015

(54) Laminates Comprising Oligomer-Grafted Nanofillers and Advanced Composite Materials

(71) Applicants: Reagents of the University of Minnesota, Minneapolis, MN (US); Adama Materials, Inc., Honolulu, HI (US)

(72) Inventors: Christopher W. Macosko, Minneapolis, MN (US); Andreas Stein, St. Paul, MN (US); Yuqiang Qian, New Brighton, MN (US); Gregory Moriarty, Roseville, MN (US); Siyao He, Minneapolis, MN (US); Francis R. Thibodeau, Oakland, CA (US)

(21) Appl. No.: 14/723,835

(22) Filed: May 28, 2015

Related U.S. Application Data
(60) Provisional application No. 62/004,529, filed on May 29, 2014.
(60) Provisional application No. 62/063,995, filed on Oct. 15, 2014.

(51) Int. Cl. C08K 3/20; B29C 70/44; B32B 5/02; B32B 27/06; B32B 15/08; B29C 70/78; B32B 27/20

(52) U.S. Cl. CPC C08K 3/20; B29C 70/78; B29C 70/443; B32B 27/20; B32B 27/06; B32B 15/08; B32B 5/022; B32B 5/024; B32B 5/026; B29K 2067/06

(57) ABSTRACT

The invention concerns nanofiller composition comprising (i) a nanoparticle; (ii) a plurality of coupling groups bonded to the nanoparticle; (iii) one or more (a) oligomers or (b) organic isocyanate residues bonded to the one or more coupling groups; and, optionally, (iv) one or more dispersing moieties that facilitate dispersion of the nanoparticle bonded to one or more of the coupling groups or organic isocyanate residues; as well as laminates comprising such nanoparticles in at least one layer.

### CROSS REFERENCE TO RELATED APPLICATIONS

This application claims benefit of U.S. Patent Application No. 62/004,529, filed May 29, 2014 and U.S. Patent Application No. 62/063,995, filed Oct. 15, 2014, the disclosures of each are incorporated herein in their entireties.

### GOVERNMENT RIGHTS

Inventions disclosed herein may have been supported by the U.S. Government under one or more grants in connection with the National Science Foundation through the NNIN program, and at the College of Science and Engineering Polymer Characterization Facility, University of Minnesota, which has received capital equipment funding from the NSF through the MRSEC.

### TECHNICAL FIELD

The disclosed inventions are in the field of laminates comprising composite materials and methods of making same.

### BACKGROUND

Polymeric composite materials are used in a wide variety of applications, from transportation vehicles to sporting equipment, and a variety of mechanical parts. Owing to their relatively low density and high strength, polymeric composite materials are advantageously used as a replacement for heavier metallic materials. However polymeric composite materials lack certain desirable properties compared to metals, such as high impact strength (e.g., “toughness”), electrical conductivity, and barrier against molecular transport. Previous attempts have been made to include filler particles in the polymeric composite materials to improve these properties. However the mechanical properties of such composite materials often suffer as a result of incompatibility between the filler particle and the polymeric matrix. Accordingly, there is a need to provide filler particles that are more compatible with polymeric matrices. There is also a need to improve the mechanical properties of polymeric composite materials for use in laminate constructs.

### SUMMARY

Provided herein are nanofiller compositions comprising: (i) a nanoparticle; (ii) a plurality of coupling groups bonded to the nanoparticle; (iii) one or more (a) oligomers or (b) organic isocyanate residues bonded to the one or more coupling groups; and, optionally, one or more dispersing moieties that facilitate dispersion of the nanoparticle bonded to one or more of (i) the coupling groups or (ii) organic isocyanate residues. In certain embodiments, the nanoparticle comprises graphene oxide. In some embodiments, the dispersing moieties comprise C₆-C₁₈ alkyl groups.

Preferred isocyanate residues are derived from 3-isopropenyl-α,α-dimethylbenzyl isocyanate (TMI) or 4,4′-diphenylmethane diisocyanate (MDI).

In certain embodiments, the nanoparticle comprises graphene oxide. Some preferred compositions comprise TMI-GO. Some compositions comprise TMI-GO or TMI-GO-Stearyl or dual TMI and alkylamine modified GO, or TMI-GO-Lauryl.

Some nanofiller compositions have one or more coupling groups that are covalently bonded to the nanoparticle. In other nanofiller compositions, the one or more coupling groups are ionically bonded to the nanoparticle.

While any suitable coupling group may be utilized, preferred coupling group include hydroxy, carboxyl, amino, alkenyl, isocyanate, and epoxide. Other coupling groups include organic silane, di-isocyanate, di-amine, or quaternary amine Certain coupling groups are dendritic, such as polyamine, polyisocyanate or polyol.

Certain compositions have an average number of repeating units in oligomers attached to the nanoparticle through the one or more coupling groups is in the range of about 2 to about 100.

The invention also concerns composites comprising (i) a polymer matrix and (ii) a nanofiller composition described herein. In some of these compositions, the weight percent of the nanofiller composition based on total weight of the composite is in the range of from about 0.005 wt % to about 20 wt %, or about 0.01 wt % to about 10 wt % or about 0.05 wt % to about 1 wt %, or about 0.02 wt % to about 0.04 wt %.

In some embodiments, the nanofiller composition is covalently bonded to the polymer matrix. In other embodiments, the nanofiller composition is ionically bonded to the polymer matrix.

The invention also concerns methods for depositing nanofiller composition disclosed herein in a polymer matrix comprising dispersing the nanofiller composition in the polymer matrix, wherein the polymer matrix comprises one or more polymerizable units; wherein the nanofiller composition improves dispersion, interfacial strength, or both dispersion and interfacial strength between the nanofiller composition and the polymer matrix. In some embodiments, the dispersing is performed by solvent blending or melt compounding.

In certain aspects, the invention concerns methods for making a composite, comprising (i) dispersing a nanofiller composition described herein in a fluid comprising one or more first monomers, the oligomer portion of the oligomer-grafted nanofiller being derived from at least one polymerizable unit corresponding to the one or more second monomers; and (ii) polymerizing the first and second monomers. In some embodiments, the polymerizing step is thermally initiated. In other embodiments, the polymerizing step is photo-initiated.

The invention also concerns certain compositions disclosed herein. These include TMI-GO, TMI-GO-Stearyl, and dual TMI and alkylamine modified GO, and TMI-GO-Lauryl.

Also provided herein are laminates comprising: (a) a first layer comprising polymeric matrix comprising polymers derived from a plurality of first polymerizable units and a nanofiller composition, the nanofiller composition comprising: (i) graphene oxide nanoparticles; (ii) one or more coupling groups bonded to the graphene oxide nanoparticle, and (iii) one or more oligomers bonded to the one or more coupling groups; and (b) a second layer; the first and second layers being bonded together.

Some compositions comprise one or more dispersing moieties that facilitate dispersion of the graphene oxide nanoparticle bonded to one or more of the coupling groups. Preferred dispersing moieties include C₆-C₁₈ alkyl groups. The alkyl groups may be linear or branched.

In some embodiments, the nanofiller composition is in the range of from about 0.005 wt % to about 20 wt % based on the weight of the first layer.

In certain embodiments, the one or more coupling groups are covalently bonded to the nanoparticle. In other embodiments, the one or more coupling groups are ionically bonded to the nanoparticle. Suitable coupling groups include —OH, —CO₂H, —NH₂, alkene, —NCO, and epoxide. In some embodiments, the coupling group comprises an organic silane, diisocyanate, diamine, primary amine, secondary amine, tertiary amine or quaternary amine. The coupling group may be dendritic, a polyamine, polyisocyanate or polyol in some embodiments.

Some preferred polymers of the first layer are thermoset resins. One preferred polymer is an unsaturated polyester. Certain unsaturated polyesters are derived from one or more of a diacid component selected from orthophthalic acid and maleic acid and a diol component selected from propylene glycol and ethylene glycol. The unsaturated polyester additionally may also comprise styrene residues.

Preferred graphene oxide (GO) nanoparticles include GO-vinyl, GO-2-vinyl, GO-vinyl-alkane, TMI-GO dihexylamine, TMI-GO, TMI-GO-Stearyl, TMI-GO-Lauryl, and dual TMI and alkylamine modified GO, where TMI is 3-isopropenyl-α,α-dimethylbenzyl isocyanate.

Any suitable second layer may be used. In some embodiments the second layer is a polymer film, a woven fiber sheet, a non-woven fiber sheet, or metal sheet. Some second layers include chopped strand mat, continuous strand mat, woven fabric, knitted fabric or stitched fabric constructs. Any suitable material may be used to construct the second layer. These materials include of fiberglass, carbon fiber, aramid, basalt and metals. Suitable metals include steel (including stainless steel, galvanized steel and carbon steel), tin, brass, nickel, titanium and aluminum.

It should be noted that the second layer may be one layer or comprise a plurality of sub-layers. In addition, a third layer disposed between the first layer and the second layer may be present. One or both of the second layer the third layer comprises a plurality of sub-layers.

In an additional aspect, the invention concerns pre-laminate layers suitable for bonding to one or more substrates to form a laminate or serving as a pre-preg. The pre-laminate comprising: a polymeric matrix comprising polymers derived from a plurality of first polymerizable units and a nanofiller composition, the nanofiller composition comprising: graphene oxide nanoparticles; one or more coupling groups bonded to the graphene oxide nanoparticle; and one or more oligomers bonded to the one or more coupling groups. If used as a pre-preg, the layers are suitable for later modification or formation into an article.

The invention also concerns oligomer-grafted nanofiller compositions for disposition in a polymer matrix, the polymeric matrix comprising polymers derived from a plurality of polymerizable units, the nanofiller composition comprising: a nanoparticle; one or more coupling groups bonded to the nanoparticle; and one or more oligomers bonded to the one or more coupling groups.

Also provided are oligomer-grafted nanofiller compositions for disposition in a polymer matrix, the polymeric matrix comprising two or more polymerizable units, the nanofiller composition comprising: a nanoparticle; one or more coupling groups bonded to the nanoparticle; and one or more oligomers bonded to the one or more coupling groups, wherein the oligomer improves dispersion, interfacial strength, or both dispersion and interfacial strength between the nanoparticle and the polymer matrix.

Also provided are composites comprising a composition of an oligomer-grafted nanofiller and polymer composite having a polymer matrix and one or more oligomer-grafted nanofillers dispersed within the polymer matrix. The oligomer-grafted nanofiller can include a nanoparticle, one or more coupling groups bonded to the nanoparticle, and one or more oligomers bonded to the one or more coupling groups.

Furthermore, the present disclosure provides methods for making oligomer-grafted nanofillers and composites. The methods for making oligomer-grafted nanofillers can include grafting a nanoparticle with one or more oligomers to form an oligomer-grafted nanofiller. The methods for making an oligomer-grafted nanofiller can also include reacting a nanoparticle with one or more coupling agent(s) to form a coupling agent-bonded nanoparticle and reacting the coupling agent-bonded nanoparticle with one or more oligomers to form an oligomer-grafted nanofiller.

In further embodiments, there are provided composites, comprising: a polymer matrix; and one or more oligomer-grafted nanofillers dispersed within the polymer matrix, wherein the oligomer-grafted nanofillers comprise a nanoparticle, one or more coupling groups bonded to the nanoparticle, and one or more oligomers bonded to the one or more coupling groups. Additionally, dispersing moieties that facilitate dispersion of the nanoparticles into the polymer matrix (such as alkyl chains) may be incorporated into the nanofiller via coupling groups.

Also provided are methods for making composites, comprising dispersing an oligomer-grafted nanofiller in a polymer matrix, wherein the polymer matrix comprises one or more polymerizable units and effectuating bonding between the oligomers and the polymer matrix. The oligomer-grafted nanofiller can include a nanoparticle and one or more oligomers covalently bonded to the nanoparticle through a coupling agent.

Methods for making a composite are also provided, the methods comprising dispersing an oligomer-grafted nanofiller in a fluid comprising one or more monomers, the oligomer portion of the oligomer-grafted nanofiller being derived from at least one polymerizable unit corresponding to the one or more monomers and polymerizing the monomer.

In addition articles made from the oligomer-grafted nanofiller composite provided herein are also disclosed.

In another aspects, the invention concerns processes for forming a laminate, comprising bonding a first layer to a second layer, wherein the first layer comprises a first layer comprising polymeric matrix comprising polymers derived from a plurality of first polymerizable units and a nanofiller composition, the nanofiller composition comprising: (i) graphene oxide nanoparticles; (ii) one or more coupling groups bonded to the graphene oxide nanoparticle, and (iii) one or more oligomers bonded to the one or more coupling groups. Any suitable process may be used for forming the laminate including hand-layup methods.

Vacuum infusion techniques may also be used in forming the articles of the invention. In some processes, the method comprising utilizing a vacuum infusion process to form the first layer on a substrate comprising the second layer. A third layer may also be included in the process either as part of the substrate or as a layer applied after addition of the first layer to the substrate. Additionally, an outer layer (protective in some embodiments) may be added to one or both sides of the laminate.

### BRIEF DESCRIPTION OF THE DRAWINGS

The present disclosure is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale. In the drawings:

FIG. 1 illustrates a method (100) for attaching coupling agents (110) to a nanoparticle (105) to form a nanoparticle that is bonded to one or more coupling agents (115).

FIG. 2 illustrates a method (120) for attaching oligomers (125) to the coupling agents (110) that are attached to a nanoparticle (105) in a nanoparticle that is bonded to one or more coupling agents (115) to form an oligomer-grafted nanofiller (130).

FIG. 3 illustrates a method (200) for attaching a dendritic coupling agent (210) to a nanoparticle (205) to form a nanoparticle that is bonded to one or more dendritic coupling agents (215) and subsequently attaching oligomers (225) to the dendritic coupling agents (210) of the nanoparticle that is bonded to one or more dendritic coupling agents (215) to form an oligomer-grafted nanofiller (230).

FIG. 4 illustrates a method (300) for dispersing oligomer grafted nanofillers (330) including a nanoparticle (305) and oligomers on the surface of the nanoparticle (305) forming an oligomer shell (335), adding the oligomer grafted nanofillers (330) to a solution of monomer (340) and polymerizing the monomers to form a composite material (345). As shown in the embodiment illustrated in FIG. 4, once the monomer solution has been polymerized, there is no visible interface between the polymerized shells (335) of the oligomer-grafted nanofillers (330) and the polymer matrix (350).

FIG. 5 illustrates a method of the functionalization of graphene oxide (GO) using methylene diphenyl diisocyanate (MDI) in a first step and amine-terminated polybutadiene-polyacrylonitrile oligomer (ATBN) in a second step.

FIG. 5A illustrates the chemical structure of ATBN.

FIG. 6 shows the FT-IR spectra of ATBN-GO, GO-NCO, and GO.

FIG. 7 shows the x-ray diffraction spectra of ATBN-GO, MDI-GO, and GO.

FIG. 8 presents TEM images of epoxy nanocomposites with 0.16 wt % of (a) GS1, (b) GS2, (c) GO, and (d) GA.

FIG. 9 shows dynamic mechanical analysis of the neat epoxy and epoxy/graphene nanocomposites: (a) storage modulus, E′, and (b) loss modulus, E″.

FIG. 10 presents (a) flexural modulus, (b) flexural strength, (c) fracture toughness, and (d) fracture energy plots of epoxy nanocomposites. To manifest the effect at small loadings, the increment is 0.04 for x<0.1 and 0.1 for x>0.1. The scale change in the x-axis is indicated by the dashed line.

FIG. 11 shows the correlation of the proposed microcrack mechanism to the K_{1c} of E_GS1 at different graphene loadings. At 0.02 wt % loading, the microcracks can be independently distributed, whereas at loadings higher than 0.04 wt %, microcracks coalesce due to the short interparticle distance.

FIG. 12 presents SEM fractographs of (a) neat epoxy and E_GS1 composites at graphene loadings of (b) 0.02 wt %, (c) 0.04 wt %, (d) 0.16 wt. The images in (e) and (f) are higher magnification images for 0.02 wt % and 0.16 wt % loadings, respectively. White arrows indicate the crack propagation direction.

FIG. 13 presents SEM fractographs of (a,b) E_GS2, (c,d) E_GO, and (e,f) E_GA. Graphene loadings shown are weight %. White arrows indicate the crack propagation direction.

FIG. 14 presents experimental and theoretical modulus data for epoxy nanocomposites with each graphene: Mori-Tanaka theoretical predictions were estimated with (a) GS2 (aspect ratio of 100), (b) GO (aspect ratio of 40), and (c) GA (aspect ratio of 60) in the exfoliated state, respectively.

FIG. 15 shows (a) stress-strain curves and (b) load-displacement curves of E_Neat and E_GA_{—}04 samples. In compact tension tests, both samples had the same crack length of a=6.09 mm.

FIG. 16 presents toughening mechanisms in rigid particle-filled epoxies: (a) crack deflection, (b) crack pinning, (c) microcrack formation. The direction of crack propagation is indicated by the red arrow.

FIG. 17 presents TEM images of E_GS1_{—}04 and E_GS1_{—}16. No significant aggregation of graphene particle was observed.

FIG. 18 presents SEM fractographs of E_GS1 and E_GS2 with 0.02 and 0.16 wt % graphene loadings. White arrows indicate the crack propagation direction. Scale Bar: 20 μm.

FIG. 19 presents geometries of ASTM specimens for (a) three-point bending (ASTM D790) and (b) compact tension (ASTM D5045) tests. a includes saw cut of 4 mm and 2 mm precrack. Units: mm. a=6±0.6 mm.

FIG. 20 presents an illustration of epoxy toughening with low graphene loading.

FIG. 21 presents an overview of vacuum infusion processing for laminate production.

FIG. 22 presents an illustration of interlaminar fracture toughness (ILFT) testing.

FIG. 23 presents a plot of load versus displacement view of interlaminar fracture toughness

FIG. 24 presents interlaminar fracture toughness of unidirectional glass fiber-reinforced laminates plotted against crack propagation length.

FIG. 25 presents interlaminar fracture toughness of woven roving laminates plotted against crack propagation length.

FIG. 26 shows one synthesis scheme for “TMI-GO” fillers.

FIG. 27 shows a synthesis scheme for TMI-GO-40° C.-1x.

FIG. 28 shows a synthesis scheme for TMI-GO-60° C.-2x-D.

FIG. 29 presents a synthetic scheme for TMI-GO-40° C.-1x in mixed diluent.

FIG. 30 presents a dual synthesis scheme for GO filler having multiple amine modifications.

FIG. 31 shows a synthetic scheme for TMI-GO-60° C.-2x-D-Stearylamine

FIG. 32 presents a scheme showing processing of dual-functionalized fillers in a UP resin.

### DETAILED DESCRIPTION OF ILLUSTRATIVE EMBODIMENTS

The present invention may be understood more readily by reference to the following description taken in connection with the accompanying Figures and Examples, all of which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to the features and methods of making and using oligomer-grafted nanofillers and composite materials that include oligomer-grafted nanofillers, as well as the oligomer-grafted nanofillers and composite materials that include oligomer-grafted nanofillers themselves, and vice versa. Each of these descriptions is applicable to use of such materials in laminates.

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described herein.

Oligomer-grafted nanofiller (OGN) compositions of the invention can be used for disposition in a polymer matrix that includes polymers derived from a plurality of polymerizable units. The nanofiller composition can include a nanoparticle, one or more coupling groups bonded to the nanoparticle, and one or more oligomers bonded to the one or more coupling groups. In an embodiment the oligomers can be derived from two or more polymerizable units where at least one polymerizable unit can be at least substantially similar to at least one of the polymerizable units of the polymer matrix. In another embodiment the oligomer comprises two or more polymerizable units and can improve dispersion, interfacial strength, or both dispersion and interfacial strength between the nanoparticle and the polymer matrix.

Suitable nanofillers (for example, graphene, graphene oxide, carbon nanotubes) can be grafted with single-type or multiple oligomer surface groups that are either identical in composition to the host polymer matrix or otherwise chosen to improve dispersion and/or interfacial strength with the host. Because of the resulting similarity between nanofiller and host matrix, high dispersion of nanofiller in the matrix can be achieved. The strong bond between filler and surface oligomer groups and the strong interactions between surface oligomer groups and the host polymer matrix ensure a strong interface between all components. Good dispersion and strong interfaces can ensure effective load transfer between the polymer matrix and the filler to enhance the toughness, stiffness, and dimensional stability of the composites. The approach also includes grafting a first oligomer type to aid in dispersion or interfacial strength and a second, or greater number of types, to achieve desirable materials properties such as toughening, etc.

Suitable nanoparticles can be selected from any particle having at least one characteristic dimension in the range of from about 1 nm to about 100 nm and that can be used as a filler in a polymer matrix. Suitable nanoparticles used herein can include a carbonaceous material, which, as used herein refers to a material having one or more carbon atoms. Suitable carbonaceous nanoparticles can include, but are not limited to, single-walled carbon nano-tubes, multi-walled carbon nanotubes, carbon nanofibers, graphene sheets, graphene oxide nanoparticles, graphite nanoparticles, fullerene particles, carbon blacks, or activated carbons. Suitable nanoparticles can also include metal oxides, such as silica, layered silicates, clays, ceramics, and layered chalcogenides. Nanoparticles that are useful in the invention can also include any combination or subcombination of the aforementioned materials.

As used herein, the term “coupling group” refers to any chemical functionality that serves to attach an oligomer or a dispersing group to the surface of the nanoparticle. A coupling group can also be a reactive group that attaches to another coupling group that is bonded or otherwise attached to the nanoparticle. It is to be understood that the term coupling group, therefore, can refer to the entire moiety that serves to bridge the nanoparticle and one or more oligomers, and the term coupling agent can also refer to any subpart of the moiety that connects the nanoparticle and one or more oligomers. For example, a coupling group can include a first coupling group, also referred to as an anchoring group, that bonds directly to the nanoparticle and a second coupling group that bonds to the anchoring group and serves as the point of attachment for one or more oligomers. The coupling group or anchoring group can be a functionality on the surface of the nanoparticle that is intrinsic to the structure of the nanoparticle. For example, an intrinsic coupling group or anchoring group can include —OH, —COOH, or other reactive functionality, depending on the structure of the nanoparticle. Alternatively, the coupling group or anchoring group can be a reactive species that is attached to a nanoparticle by way of a chemical reaction. In some materials such as, for example, graphene, the density of intrinsic anchoring points can be quite low. It may be increased by chemical treatment that increases the number of intrinsic surface groups. For example, the coupling group or anchoring group can include —OH, —COOH, —NH₂, —C═C, —NCO, epoxide, or other reactive functionality. The coupling group or anchoring group can be bonded to the nanoparticle, such as covalently bonded or ionically bonded. As described above, a coupling group can be attached to the nanoparticle through another coupling group or anchoring group. For example, a coupling group includes, but is not limited to, organic silane, di-isocyanate, di-amine, quaternary amine, or other reactive functionality. The number of anchoring points for attachment of oligomer to the nanoparticle can also be increased by attaching branched surface groups that contain multiple points for attachment to enable dendritic growth. Thus, a coupling group can be dendritic and have multiple reactive sites such that one or more oligomers can be attached to it. Example dendritic coupling groups include, but are not limited to polyamine, polyisocyanate and polyol.

In OGN compositions of the invention, one or more oligomers can be attached to a coupling agent that is attached to a nanoparticle. That is, one oligomer can be bonded to one coupling agent that is bonded to the nanoparticle. Alternatively, more than one oligomer can each be bonded directly to a single coupling agent, or such as to multiple sites on a single coupling agent that is bonded to the nanoparticle, or one oligomer can be bonded directly to more than one coupling agent, such as through multiple sites on the single oligomer. One or more oligomers can be attached to one or more coupling agents by chemical bonding, such as covalent bonding or ionic bonding. For example, multifunctional crosslinking agents comprising n functional groups can be attached to the coupling agent, to provide n−1 functional groups for linking up to n−1 oligomers per coupling agent.

Suitable oligomers can be derived from 2 to about 200 polymerizable units, more preferably from about 10 to about 100 polymerizable units, and even more preferably from about 20 to about 50 polymerizable units. In terms of molecular weight, suitable oligomers can typically have a molecular weight in the range of from about 100 g/mol to about 10,000 g/mol, more preferably in the range of from about 500 g/mol to about 5,000 g/mol, and even more preferably in the range of from about 1000 g/mol to about 2,500 g/mol.

In certain embodiments, suitable oligomers can also refer to a polymer comprising in the range of from about 2 to about 100 polymerizable units. In some embodiments, suitable oligomers for use in OGN compositions of the invention can have from about 2 to about 100 polymerizable units, or from about 2 to about 80 polymerizable units, or from about 2 to about 60 polymerizable units, or from about 5 to about 40 polymerizable units, or from about 10 to about 20 polymerizable units. Oligomers can also be referred to herein as a low-molecular weight version of a corresponding polymer. The strength of interfacial interactions can be controlled by the chain length (molecular weight) of the oligomeric groups. For example, longer chain lengths can provide stronger van der Waals interactions with the polymer matrix.

An oligomer can be a homooligomer, wherein each of the polymerizable units is at least substantially the same, or can be a copolymer including two or more polymerizable units that are not substantially the same, or are substantially different. As used herein, “substantially the same,” or “substantially similar” in reference to polymerizable units refers to polymerizable units that have the same basic chemical structure, but may vary in one or more substituents without significantly affecting the chemical properties of the polymerizable unit. OGN compositions of the present invention can include oligomers that are one or more of the following types of copolymer: random, alternating, periodic, and block. Oligomers suitable for use in the OGN compositions of the invention include linear oligomers or branched oligomers.

While OGN compositions of the invention include at least one or more oligomers attached to the nanoparticle through a coupling group, preferably the amount of oligomers attached to the nanoparticle through a coupling group is sufficient to achieve complete or partial surface coverage of the nanoparticle. The strength of interfacial interactions can depend on the density of oligomeric surface groups surrounding the filler nanoparticle. For example, in a functionalization of a nanoparticle, oligomeric coverage can be described in terms of number of oligomers per area. For example, oligomeric coverage of a nanoparticle can be in a range of from about one oligomer per nm² to about 1 oligomer per 10,000 nm², or more preferably in a range of from about one oligomer per nm² to about one oligomer to about 1,000 nm². For example, in a functionalization of graphene nanoparticle, oligomeric coverage can be in a ratio of about one oligomer per every 100 to 200 surface carbon atoms, about one oligomer per 70 surface carbon atoms, or about one oligomer per every 40 surface carbon atoms. In other embodiments the number density of oligomers to surface carbon atoms can be as low as 1 oligomer per about 10,000 surface carbon atoms to as high as 1 oligomer per about 10 surface carbon atoms. It will be appreciated that the required number density per surface carbon atom or density per surface area to effect coverage of the surface of a nanoparticle generally decreases as the size (e.g., atomic mass) of the oligomer increases. Hence fewer lengthier oligomers can provide similar surface coverage as more, shorter, oligomers. The number of oligomers per surface area of nanoparticle can be measured by any method known to a person of skill in the art, including transmission electron microscopy.

The functionalization density of oligomer coverage of the nanoparticle surface can also be characterized by thermogravimetric analysis (TGA). In some embodiments a mass fraction of organic matter attributable to the surface oligomers (and any organic coupling agent to which they may be attached) is in a range from about 2% to about 90%, and more preferably in a range of from about 5% to about 80% based on total weight of the OGN. It will be appreciated that the mass fraction will depend on the molecular weight of the oligomers, and the higher the molecular weight of the oligomers, the higher the mass fraction of organic matter will be in OGNs. Similarly, it will be appreciated that the mass fraction will depend on the molecular weight to an organic coupling agent to which the oligomer is attached, if the oligomer is attached to the nanoparticle through an organic coupling agent.

OGN compositions can include one or more oligomers derived from two or more polymerizable units where at least one polymerizable unit can be at least substantially similar to at least one of the polymerizable units of the polymer matrix. An OGN composition of the invention that can be used as a filler in a polymer containing a single type of repeating unit, i.e., a homopolymer, can include one or more oligomeric groups that are a low-molecular weight version of the matrix polymer. For example, an OGN composition of the invention for use as a filler in polystyrene can include one or more oligomeric groups that are low-molecular weight polystyrene. For example, an OGN composition of the invention for use as a filler in polyethylene can include one or more oligomeric groups that are low-molecular weight polyethylene. An OGN composition of the invention that can be used as a filler in a polymer containing two or more substantially different polymerizable units, i.e., a copolymer can include one or more oligomers wherein at least one polymerizable unit of the two or more oligomers is at least substantially similar to each of the two or more substantially different polymerizable units of the polymeric matrix. Thus, an OGN composition of the invention that can be used as a filler in a copolymer can include one or more oligomeric groups that are each the low-molecular weight oligomer of each counterpart of the copolymer. That is, each oligomer group can include two or more of substantially the same polymerizable unit, that polymerizable unit can be the same as at least one polymerizable unit of the polymer matrix in which the OGN is intended to be used. For example, an OGN composition of the invention for use as a filler in polyethylene oxide-polystyrene can include one or more oligomeric groups that are low-molecular weight polyethylene oxide and one or more oligomeric groups that are low-molecular weight polystyrene. An OGN composition of the invention that can be used as a filler in a polymer containing a cross-linked network including different polymerizable units can include one or more oligomeric groups that are linear oligomers each composed of similar polymerizable units as the polymer matrix. These examples are illustrative only and are not meant to be limiting.

Suitable polymerizable units that comprise the oligomers can be selected from any type of polymerizable monomer, as well as combinations of monomers such as in a copolymerization or block-copolymerization. Examples of suitable monomers include, but are not limited to, any of the monomers that can be polymerized using free-radical polymerization, condensation polymerization, ring-opening polymerization, and the like. Suitable free-radical monomers include vinyl aromatic monomers (e.g., styrenes), dienes (e.g., butadiene and isoprene), acrylics, methacrylics, nitrogen-containing vinyl compounds such as vinylpyridines, and any combination thereof.

Suitable condensation polymers include, but are not limited to, polyesters (PEs), polyamides (PAs), and polycarbonates (PCs). Suitable polyesters include homo- or copolyesters that are derived from aliphatic, cyclo aliphatic or aromatic dicarboxylic acids and diols or hydroxycarboxylic acids. Non-limiting, exemplary polyesters include poly(ethylene terephthalate) (PET), poly(butylene terephthalate) (PBT), poly(ethylene naphthalate) (PEN), and poly(butylene naphthalate). Suitable polyamides include polyamides produced by polycondensing a dicarboxylic acid with a diamine, polyamides produced by polymerizing a cyclic lactam, and polyamides produced by co-polymerizing a cyclic lactam with a dicarboxylic acid/diamine salt. The polyamides include polyamide elastomer resins. Suitable polyamide elastomer resins include nylon 6, nylon 6-6, nylon 6-10, nylon 11, nylon 12, and co-polymers and blends of any two or more such polyamides. Suitable polycarbonates include, but are not limited to, aromatic polycarbonates produced by reactions of bisphenols with carbonic acid derivatives such as those made from bis-phenol A (2,2-bis(4-hydroxyphenyl)propane) and phosgene or diphenyl carbonate.

In another embodiment suitable oligomers comprise two or more polymerizable units and can improve dispersion, interfacial strength, or both dispersion and interfacial strength between the nanoparticle and the polymer matrix. A person of skill in the art will understand how to measure the dispersion of the OGN in the polymer matrix (and of the nanoparticle in the polymer matrix as a reference point). For example, any one or more of transmission electron microscopy, rheology, small angle X-ray scattering or X-ray diffraction methods can be used to quantify dispersion. For example, in rheology one can measure the gel point, which is the concentration of OGN at which the slope of G′ vs oscillation frequency approaches zero at low frequency, i.e., the percolation concentration of filler particles. As used herein, G′ is the storage modulus of a material determined using dynamic mechanical analysis. For OGNs prepared using graphene sheet nanoparticles or carbon nanotubes, the percolation concentration is typically in the range of from about 0.05% to about 5%, and more typically about 0.5%. Percolation concentration of conductive particles and other high-contrast nanoparticles (i.e., having a high electron density such as metals and atoms having an atomic number greater than about 20) can also be measured using TEM. In TEM, the average number of particles per square micrometer can be counted. In addition, dispersion can be quantified by measuring the average interparticle separation or for plate-like particles direct measurement of thickness and length. Aspect ratio and particle size can also be measured by TEM. A person of skill in the art will also understand how to measure the interfacial strength between the OGN and the polymer matrix (and between the nanoparticle and the polymer matrix as a reference point). Interfacial strength measurements are desirably analyzed separately from improvements in dispersion; for example improvements in interfacial strength can be measured by modulus or impact strength. Modulus or impact strength measurements can be used to infer improvements in interfacial strength. Methods for quantifying the dispersion and interfacial strength of a nanoparticle in a composite material have been described in Kim H, Macosko C M, “Processing-Property Relationships of Polycarbonate/Graphene Composites,” Polymer (2009) and Kim H, Macosko C M, “Morphology and Properties of Polyester/Exfoliated Graphite Nanocomposites,” Macromolecules (2008), the entire contents of which are incorporated herein by reference.

The OGNs are desirably discrete or unagglomerated and dispersible, miscible or otherwise compatible (preferably substantially compatible) with/in the polymeric matrix, and precursors thereto. In some embodiments, the selection of suitable oligomers for providing compatible OGNs for a particular polymeric matrix can be made by matching the solubility parameters of the oligomers to the solubility parameters of the polymeric matrix. Schemes for estimating how well matched the solubility parameters are, include the Van Krevelen parameters of delta d, delta p, delta h and delta v. See, for example, Van Krevelen et al., Properties of Polymers. Their Estimation and Correlation with Chemical Structure, Elsevier Scientific Publishing Co., 1976; Olabisi et al., Polymer-Polymer Miscibility, Academic Press, NY, 1979; Coleman et al., and Specific Interactions and the Miscibility of Polymer Blends, Technomic, 1991. Delta d is a measure of the dispersive interaction of the material, delta p is a measure of the polar interaction of the material, delta h is a hydrogen bonding parameter of the material and delta v is a measurement of both dispersive and polar interaction of the material. Such solubility parameters may either be calculated, such as by the group contribution method, or determined by measuring the cloud point of the material in a mixed solvent system consisting of a soluble solvent and an insoluble solvent. The solubility parameter at the cloud point is defined as the weighted percentage of the solvents. Typically, a number of cloud points are measured for the material and the central area defined by such cloud points is defined as the area of solubility parameters of the material.

In certain embodiments of the present invention, the solubility parameters of the OGNs and that of the composite can be substantially similar. In this case, compatibility between the OGN and the composite may be improved, and phase separation and/or aggregation of the OGN is less likely to occur.

The OGNs may be dispersed in a polymerization solvent used to prepare composite, or they may be isolated by, for example, vacuum evaporation, by precipitation into a non-solvent, and spray drying; the isolated OGNs may be subsequently redispersed within a material appropriate for incorporation into a polymeric matrix to give rise to a composite.

The OGN compositions described herein can be in the form of a particle-dispersion in a fluid. Such a fluid can be an organic liquid or an aqueous liquid. OGNs prepared in a suitable aqueous or non-aqueous fluid can be subsequently dried to a powder form, such as by spray-drying or lyophilization. Hence, the OGN compositions described herein can also be provided as a powder.

Suitable OGN compositions can be used as filler in a polymeric matrix. As filler in a polymeric matrix, OGN compositions of the invention can impart any of a number of properties to the resulting composite. For example, OGN compositions of the invention can impart greater stiffness, toughness, dimensional stability, thermal stability, enhanced electrical conductivity, enhanced thermal conductivity, greater barrier properties, strength, modulus, Tg, chemical corrosion resistance, UV degradation resistance, abrasion resistance, fire resistance or fire retardance, increased electrical conductivity, increased thermal conductivity, increased radio wave deflection, or any combination or subcombination thereof, to the polymer matrix when the oligomer-grafted nanofiller is disposed in the polymer matrix compared to the polymer matrix free of the oligomer-grafted nanofiller. OGN compositions of the invention can be used in the manner and to impart any and all of the properties for which prior art fillers or modifiers have been used.

Methods of making OGN can include reacting a nanoparticle with one or more coupling agents to form a nanoparticle that is attached to one or more coupling agents. Alternatively, functionalized nanoparticles, or nanoparticles attached to one or more coupling agents, can be used as a starting material. Nanoparticles or nanoparticles that are attached to one or more coupling agents can be dispersed in a fluid. The fluid can be aqueous or non-aqueous.

An OGN of the invention can be made by grafting a nanoparticle with one or more oligomers to form the OGN. Methods include reacting relative amounts of oligomer, contacting groups, and nanoparticles sufficient to achieve complete or partial coverage of the surface of the nanoparticle with oligomer. In particular, an amount of coupling group can be reacted with an amount of nanoparticle that will provide oligomer with sufficient attachment points to partially or completely cover the surface of the nanoparticle. The amount of coupling groups, the efficiency of coupling, steric considerations, can affect the degree of surface coverage by oligomer, among other factors. In a non-limiting example, in a functionalization of graphene nanoparticle, an amount of coupling group can be reacted with an amount of nanoparticle that will provide sufficient attachment points to achieve oligomeric coverage of the nanoparticle in a ratio of about one oligomer per every 100 surface carbon atoms, about one oligomer per 70 surface carbon atoms, or about one oligomer per every 40 surface carbon atoms.

Oligomers can be preformed or made separately and then attached to the nanoparticle. Preferably, oligomers that are preformed can be attached to the nanoparticle by being attached to one or more coupling groups or anchoring groups on the nanoparticle. While —OH, —COOH, —NH₂, —C═C, —NCO, epoxide are preferred coupling groups for attaching oligomers, any reactive moiety that can both be attached to a nanoparticle and serve to attach an oligomer can be used in accordance with the invention. Methods for attaching preformed oligomers to coupling groups include, but are not limited to, condensation reactions such as esterification and amidation, and addition reactions, such as free radical addition, atomic transfer radical polymerization reactions, and reversible addition-fragmentation chain transfer reaction.

Alternatively, oligomers can be grown directly on coupling groups that are attached to the nanoparticle. Example coupling agents that can be used to directly grow oligomers include, but are not limited to, organic silanes, di-isocyanates, di-amines, and, for use with clay nanoparticles, and quaternary ammonium.

Once the oligomer has been linked or bonded to the nanoparticle some or all of the fluid can be removed from the OGNs. Keeping the OGNs in at least some fluid can prevent aggregation of the OGN particles.

In another embodiment of the invention, a composite material includes a polymer matrix and one or more OGNs dispersed within the polymer matrix. The one or more OGNs have been described above. Composite materials of the invention can have greater stiffness, toughness, dimensional stability, thermal stability, enhanced electrical conductivity, enhanced thermal conductivity, greater barrier properties, strength, modulus, Tg, chemical corrosion resistance, UV degradation resistance, abrasion resistance, fire resistance or retardance, increased electrical conductivity, increased thermal conductivity, increased radio wave deflection, or any combination or subcombination thereof, as compared to a composite material that is a polymer matrix including nanoparticles that do not have oligomers grafted thereto. Thus, the OGNs can impart desired properties to the polymer matrix or resulting composite material.

While composite materials of the invention can have any amount of OGN sufficient to impart a desired property to the composite material, preferably composite materials of the invention can have a weight percent of the OGN based on the total weight of the composite in the range of from about 0.005% to about 20%, or more preferably in the range of from about 0.01% to about 0.5%, or even more preferably, in the range of from about 0.001% to about 1%. Many other ranges of weight percent of the OGN based on the total weight of the composite between about 0.005% and about 20% are also possible. Any combination of a lower weight percent and a higher weight percent can be used. For example the lower weight percent can be incrementally greater than 0.005% in increments of 0.001%, for example 0.006%, 0.007%, 0.008%, 0.009%, 0.010%, 0.011%, 0.012%, and so one, all the way to 19.999%. Likewise, the higher weight percent can be incrementally smaller than 20% in increments of 0.001%, for example, 19.999%, 19.998%, 19.997%, 19.996%, 19.995%, 19.994%, 19.993%, 19.992%, 19.991%, 19.990%, 19.989%, 19.988%, and so on, all the way to 0.006%.

In compositions of the invention, one or more OGNs can be attached or bonded to the host polymer matrix. OGNs can be covalently bonded to the polymer matrix or ionically bonded to the polymer matrix. OGNs can be attached to the polymer matrix through van der Waals forces. The OGNs can be attached to the polymer matrix by way of covalent or ionic bonding of one or more oligomers of the one or more OGN to the polymer matrix or by van der Waals interactions between one or more oligomers of the one or more OGN and the polymer matrix.

The present invention also includes methods for making a composite material that includes one or more OGNs dispersed in a host polymer matrix. A method for making an OGN-polymer composite can include dispersing an OGN in a polymer matrix that includes one or more polymerizable units and effectuating bonding between the oligomers and the polymer matrix. Any OGN of the invention can be used in methods for making a composite material, such as OGN including oligomers that can improve dispersion, interfacial strength, or both dispersion and interfacial strength between the nanoparticle and the polymer matrix, or oligomers that are derived from two or more polymerizable units where at least one polymerizable unit can be at least substantially similar to at least one of the polymerizable units of the polymer matrix. Dispersing techniques include, but are not limited to, solvent blending and melt compounding. Methods of making an OGN-polymer composite can further include the step of effectuating bonding between the oligomers and the polymer matrix.

Suitable composite materials can also be made by dispersing OGNs in a plurality of monomers and subsequently carrying out a chemical reaction to polymerize the monomers. The OGNs can be applied to the host polymer by direct mixing in the monomer for the target polymer matrix. Alternatively, they can be applied through a master-batch approach, in which OGNs are dispersed at a high concentration in the monomer and the target formulation can then be achieved by diluting the master-batch with monomer. The monomers can be dispersed in a fluid, such as an aqueous or non-aqueous fluid. The chemical reaction appropriate for polymerizing the monomers after addition of the OGNs will depend on the nature of the monomers, but can be, for example, thermally initiated or photo-initiated. In some methods of the invention, the polymerizing step can give rise to at least one covalent bond between the oligomer portion of the oligomer-grafted nanofiller and the polymerized monomer.

Once the OGNs are incorporated in the polymer matrix, the interface between OGN and polymer becomes indistinguishable from the bulk phase and the overall nanocomposite will consist of highly dispersed nanofiller particles in a single phase.

In another embodiment of the invention, an article or workpiece can be made from a composite material of OGN and polymer.

### Laminates

In the manufacture of composites and laminates, many substrates may be selected. Fiber reinforcements used in these constructs include fiberglass, carbon fiber, aramid, basalt, and the like. Cost and performance are factors in selecting the proper substrate.

In addition to the selection of fiber, the construction of the substrate must be considered. One common construction is a chopped strand mat which is commonly made from fiberglass. In this construct, randomly spread short discontinuous fibers are bound with a binder. Common weights of chopped strand mat are: 0.75, 1.0, 1.5, 2.0, and 3.0 oz/yrd². These constructs are inexpensive compared to many other constructs.

Another construction is a continuous strand mat. Although other fibers may be used, fiberglass fabric often used and typically provides more structural support then a chopped strand mat. Such constructs, however, are more expensive. In one construction glass filaments are laid in a circular pattern and bound together with a binder. In some constructions, continuous strand mats are commonly used in a pultrusion process which adds cross-directional strength to the product.

An additional construction concerns woven fabrics. These fabrics utilize a wide variety of fibers, weights, and weave patterns known in the industry. Use of a woven fabric provides superior structure support compared to other products. These constructs are also good at absorbing resin. Woven constructs are widely used in areas including hand layup, vacuum infusion, compression molding, and pultrusion. An advantage to using a woven construction is that this construct is more drapable—an important property in the manufacture of many products.

Knitted or Stitched Fabrics may also be used. In these constructions layers of reinforcement may be stitched together to form composite fabrics. This construction is not limited by fiber type and many combinations may be utilized. Such constructs are versatile and may be adapted for a particular application. In these constructions, the angle of the fibers, relative to other layers, may be varied. In one example, ‘ski and snowboard manufacturers use “hybrid” stitched fabrics where there is carbon fiber running in the “zero direction”, from nose to tail of the ski, and fiberglass is used in the 90 degree (rail to rail), and in the +1-45 degree direction, to provide torsion strength.’ See, Todd Johnson, Composite Fabrics, http://composite.about.com/od/aboutaramids/a/Composite-Fabrics.htm, for a review of this and other common constructions.

### Examples

The following examples, while illustrative individual embodiments, are not intended to limit the scope of the described invention, and the reader should not interpret them in this way.

### Example 1

### Functionalization of Graphene Oxide Nanoparticle with Polybutadiene-Polyacrylonitrile Rubber Oligomer

The example is to attach a polybutadiene-polyacrylonitrile rubber oligomer on graphene oxide with a coupling agent. To functionalize graphene oxide (GO) with rubber oligomer, 0.2 g of GO was dispersed in 50 mL dimethyl formamide (DMF) by sonication, then 2 g of methylene diphenyl diisocyanate (MDI) was added. The mixture was stirred at room temperature for one day, and was then coagulated by methylene chloride. After being washed with methylene chloride at least five times by centrifugation, the isocyanate-functionalized GO was then redispersed in 100 mL of DMF. An amount of 4 g of amine-terminated polybutadiene-polyacrylonitrile (ATBN 1300x42, molecular weight 900 g/mol, 18% polyacrylonitrile), was added and the mixture was stirred at 50° C. for 12 h. ATBN-functionalized GO was separated by centrifugation and washed by with acetone for at least 5 times. The product was dispersed in t-butanol and the dispersion was subjected to freeze drying for at least 15 h at room temperature and then 3 h at 60° C. The product was obtained as a fluffy powder.

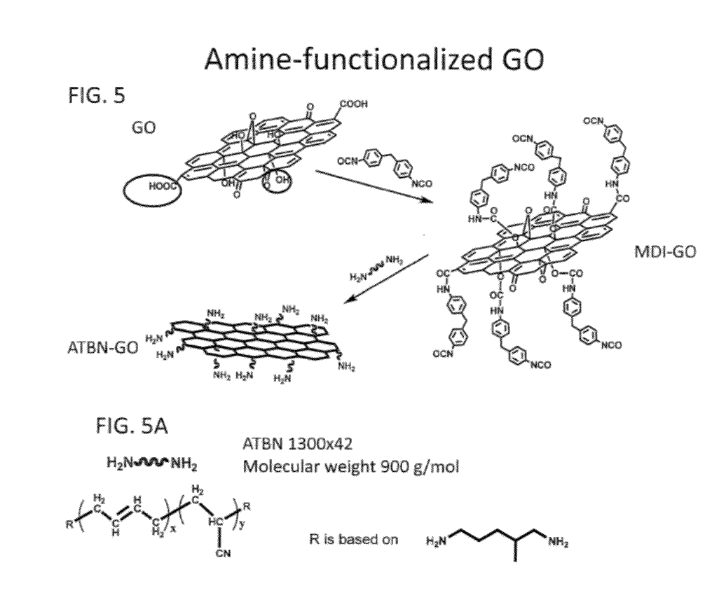

Referring now to FIG. 5, a schematic of the functionalization of graphene oxide (GO) is illustrated. At the top left, graphene oxide is provided with hydroxyl and carboxyl functionalities circled. Methylene diphenyl diisocyanate (MDI) is added to the GO to produce isocyanate-functionalized GO (MDI-GO) Amine-terminated polybutadiene-polyacrylonitrile (ATBN) is added to the MDI-GO to form ATBN-GO. FIG. 5A shows the structure of ATBN.

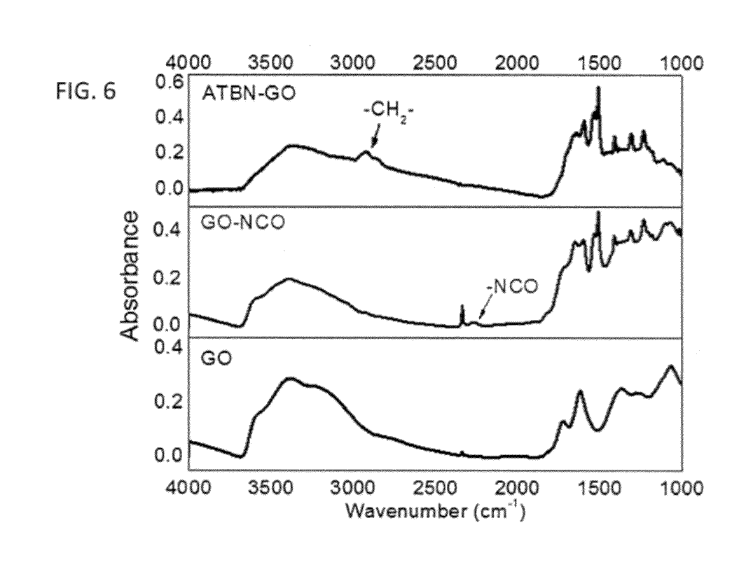

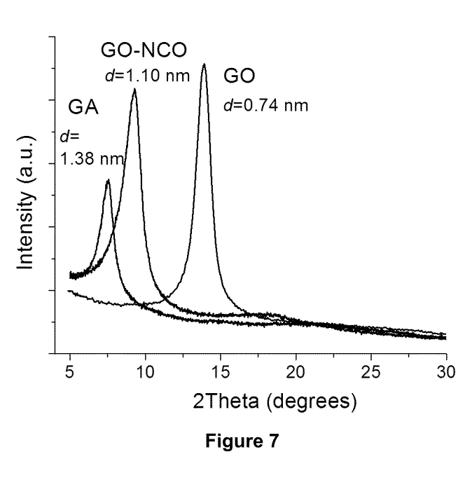

Structural characterization is shown in FIGS. 6 and 7. FIG. 6 shows the FT-IR spectra of ATBN-GO, GO-NCO, compared with the FT-IR spectrum of GO. The peak corresponding to —CH₂— is pointed out on the ATBN-GO spectrum and the peak corresponding to —NCO is pointed out on the GO-NCO spectrum. FIG. 7 shows the x-ray diffraction spectra of ATBN-GO, MDI-GO, and GO.

The functionalization density of ATBN on GO was estimated by thermogravimetric analysis (TGA) and is shown in Table 1. In calculating the functionalization density per 100 carbon atoms, the following assumptions were made: 1) only carbon was left after 800° C. and 2) the structure of the functional group is:

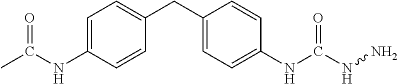 [SMILES: CC(=O)Nc1ccc(Cc2ccc(NC(=O)NN)cc2)cc1]

TABLE 1

| | Weight Loss | Functionalization Density/ |
|---|---|---|
| Sample | (250° C.-800° C.)/wt % | per 100 carbon atoms |
| GO | 17.9 | NA |
| ATBN-GO | 37.3 | 0.39 |

### Example 2

### Preparation of a Composite Material Using the OGNs of Example 1

The desired amount of ATBN-functionalized GO is dispersed in THF by ultra-sonication, then the dispersion is added to a THF solution of polybutadiene-polyacrylonitrile copolymer to achieve a final composite with 0.005 wt % to 20 wt % of modified graphene oxide. After solvent evaporation or precipitation in a non-solvent, such as methanol, the composite is obtained.

### Example 3

### Functionalization of Graphene Nanoparticle with Styrene Oligomer

To grow oligomeric styrene on graphene, silylation of graphene is achieved by stirring graphene oxide and 3-chloropropyl trimethoxy silane in ethanol at 60° C. for 12 h. Then the chlorine-functionalized graphene is dispersed in DMF with CuCl and styrene for atom transfer radical polymerization (ATRP) reaction.

### Example 4

### Functionalization of Graphene Nanoparticle with Polyester Oligomer

To grow oligomeric polyester on graphene, a similar approach as to diamine functionalization of graphene oxide is used; a substitution of diamine to hydroxyl-terminated polyester oligomer produces polyester-functionalized GO.

### Example 5

### Functionalization of Graphene Nanoparticle with Ethylene Oxide Oligomer

To grow oligomeric polyester on graphene, a similar approach as to diamine functionalization of graphene oxide is used; a substitution of diamine with polyethylene glycol (PEG) or polyethylene oxide (PEO) produces PEG/PEO-functionalized GO.

### Example 6

### Functionalization of Graphene Nanoparticle with Acrylic or Methacrylate Oligomer

To grow oligomeric acrylic or methacrylate on graphene, a similar approach as to polystyrene functionalization of graphene oxide is used; a substitution of styrene to acrylic/methacrylate monomers produces acrylic/methacrylate oligomer-functionalized GO.

### Example 7

### Functionalization of Graphene Nanoparticle with Vinyl Ester Oligomer

To grow oligomeric vinyl ester on graphene, a similar approach as to polystyrene functionalization of graphene oxide is used; a substitution of styrene to vinyl ester will produce vinyl ester functionalized GO.

### Example 8

### Functionalization of Graphene Nanoparticle with Epoxy Oligomer

To grow oligomeric epoxy on graphene, diamine-functionalized GO is used and a further reaction with epoxy resin grafts epoxy monomer on GO.

### Example 9

### Functionalization of Graphene Nanoparticle with Aramid Oligomer

To grow oligomeric aramid on graphene, a similar approach as to diamine functionalization of graphene oxide is used; a substitution of diamine with amine-terminated aramid oligomer produces aramid-functionalized GO.

### Example 10

### Functionalization of Carbon Nanotube with Oligomer

Carbon nanotubes (CNT) are treated in concentrated nitric acid to produce hydroxyl groups and carboxyl groups on CNT.

Alternatively, carbon nanotubes (CNT) are treated in a mixture of phenylene diamine/4-hydroxylethyl aniline and isoamyl nitrite in organic solvent to produce amino/hydroxyl groups on CNT.

After generating hydroxyl or amino groups on the carbon nanotube surface, oligomer can be grafted to the carbon nanotube surface using a similar approach as for graphene oxide in the above methods.

### Example 11

### Functionalization of Carbon Nanofiber with Oligomer

Carbon nanofibers are treated in a similar approach as carbon nanotubes of Example 10.

### Example 12

### Functionalization of Graphene Sheet with Oligomer

Graphene sheets are treated in a similar approach as carbon nanotubes of Example 10.

### Example 13

### Functionalization of Graphite Nanoparticle with Oligomer

Graphene nanoparticles are converted to graphene oxide after treatment in a mixture of concentrated sulfuric acid and potassium permanganate (the Hummers' method). The graphene oxide particles are then functionalized in accordance with Examples 1-9.

### Example 14

### Functionalization of Silica Nanoparticle with Oligomer

Silica nanoparticles are treated with 3-aminopropyl trimethoxysilane in ethanol to generate amino groups on the silica nanoparticle surface. After generating amino groups on the silica nanoparticle surface, oligomer can be grafted to the silica nanoparticle surface using a similar approach as for graphene oxide in the above methods.

### Example 15

### Functionalization of Metal Oxide Nanoparticle with Oligomer

Metal oxide nanoparticles are treated using a similar approach as for silica nanoparticles in the Example 14.

### Example 16

### Functionalization of Layered Silicates Nanoparticle with Oligomer

Refluxing the layered silicate nanoparticles with a solution of alkylammonium halide exchanges the interlayer metal cations to alkylammonium cation. Using octadecyl bis(2-hydroxylethyl)methyl ammonium chloride, hydroxyl group is generated on the surface of the layered silicates nanoparticle. After generating hydroxyl groups on the layered silicates surface, oligomer can be grafted to the layered silicates nanoparticle surface using a similar approach as for graphene oxide in the above methods.

### Example 17

### Functionalization of Clay Nanoparticle with Oligomer

Clay nanoparticles are treated using a similar approach as for layered silicates in Example 16.

Alternatively, oligomer can be grafted to a commercial organoclay, such as Cloisite 30B, which has two hydroxyl groups on each organic modifier, using a similar approach as for graphene oxide in the above methods.

### Example 18

### Functionalization of Layered Chalcogenide Nanoparticle with Oligomer

Terpyridine derivatives are used to chelate the surface metal atoms on chalcogenide particles. Hydroxyl groups are generated if the terpyridine derivative contains terminal hydroxyl groups. After generating hydroxyl groups on the chalcogenide particle surface, oligomer can be grafted to the chalcogenide particle surface using a similar approach as for graphene oxide in the above methods.

### Example 19

### Functionalization of Ceramic Nanoparticle with Oligomer

Ceramic nanoparticles are treated in nitric acid to activate surface hydroxyl groups. After generating hydroxyl groups on the ceramic nanoparticle surface, oligomer can be grafted to the ceramic nanoparticle surface using a similar approach as for graphene oxide in the above methods.

### Example 20

### Functionalization of Metal Nanoparticles with Oligomer

Metal nanoparticles are treated with long-chain thiols (e.g., C-12, C-16, or C-18 thiol) containing a reactive group on the opposite end to attach oligomers.

It is to be understood that while the invention has been described in conjunction with the preferred specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. In addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety, for all purposes.

### Additional Embodiments

Epoxy Toughening with Low Graphene Loading

The toughening effects of graphene and graphene-derived materials on thermosetting epoxies are investigated. Graphene materials with various structures and surface functional groups are incorporated into an epoxy resin by in situ polymerization. Graphene oxide (GO) and GO modified with amine-terminated poly(butadiene-acrylonitrile) (ATBN) are chosen to improve the dispersion of graphene nanosheets in epoxy and increase their interfacial adhesion. An impressive toughening effect is observed with less than 0.1 wt % graphene. A maximum in toughness at loadings as small as 0.02 wt % or 0.04 wt % is observed for all four types of graphene studied. An epoxy nanocomposite with ATBN-modified GO shows a 1.5-fold improvement in fracture toughness and a corresponding 2.4-fold improvement in fracture energy at 0.04 wt % of graphene loading. At such low loadings, these graphene-type materials become economically feasible components of nanocomposites. A microcrack mechanism is proposed based on microscopy of the fracture surfaces. Due to the stress concentration by graphene nanosheets, microcracks may be formed to absorb the fracture energy. However, above a certain graphene concentration, the coalescence of microcracks appears to facilitate crack propagation, lowering the fracture toughness. Crack deflection and pinning likely contribute to the slow increase in fracture toughness at higher loadings.

1. Introduction

Epoxy polymers are widely used as adhesives, coatings, and structural materials. As thermosetting materials, epoxies exhibit a high degree of crosslinking, which endows them with useful properties, such as high rigidity and strength. However, the crosslinked structure also makes epoxies intrinsically brittle and vulnerable to cracks, which limits their applications in aerospace or automotive parts. It is therefore of great interest to improve the fracture toughness of epoxies. Traditionally-applied tougheners, such as liquid rubbers and thermoplastic polymers, can increase the toughness of epoxies by forming micron-sized secondary phases, but typically, 5-20 wt % of toughener is required, causing a noticeable reduction in modulus and a suppression of glass transition temperatures. Inorganic nanofillers, such as metal oxides, nanoclays, and carbon nanomaterials, have also been extensively studied to improve the fracture toughness of epoxies. Different from polymeric tougheners, increases in the modulus and glass transition temperatures are often observed due to the high stiffness of inorganic nanofillers. However, the increase in fracture toughness obtained with inorganic nanofillers is typically less than that with polymeric tougheners.

Graphene consists of a single layer of carbon atoms and has recently emerged as a promising material for polymer nanocomposites, energy storage and electronics applications, due to its unique structure and its excellent mechanical and electrical properties. The introduction of graphene nanosheets into polymers resulted in improved mechanical, electrical, and barrier performances. Because of the high aspect ratio of graphene nanosheets, the property enhancements can be obtained at relatively small loadings, less than 0.5 wt %. For epoxy toughening, Rafiee et al. compared the fracture performance of epoxy composites with 0.1 wt % of pristine graphene, single-walled and multi-walled carbon nanotubes, and demonstrated that the composites with graphene showed the highest fracture toughness. They also found that the improvement in fracture toughness peaked at 0.125 wt % of graphene with a 65% increase. Since many industrial applications of graphene are still limited by its relatively high cost, the improvements at low loadings of graphene provide opportunities to produce cost-effective epoxy/graphene nanocomposites. Epoxy nanocomposites with surface functionalized graphene and graphene oxide (GO) were also studied, and the fracture toughness increased with graphene loading. However, all these studies used solvents, which place limitations on industrial implementation.

Motivated by the above results, we sought to investigate the toughening effects of graphene nanosheets in bulk polymerized epoxy nanocomposites. The content of graphene in the nanocomposites was kept lower than 0.3 wt %. In addition, no solvent was used in the nanocomposite preparation. Pristine graphenes, GO, and surface-modified GO were employed to prepare epoxy nanocomposites. The toughening effects of different graphene materials were demonstrated at loadings less than 0.1 wt %. Interestingly, a maximum toughening effect was observed at 0.02 wt % or 0.04 wt % of graphene loading for all the composite samples, and GO modified with specific surface groups outperformed the pristine graphenes and GO. Fractographs of the composite samples were collected to investigate the toughening mechanism. A mechanism is proposed to explain the fracture behavior of polymer composites with low loading levels of graphene.

2. Results and Discussion

2.1. Modification of Graphene Oxide

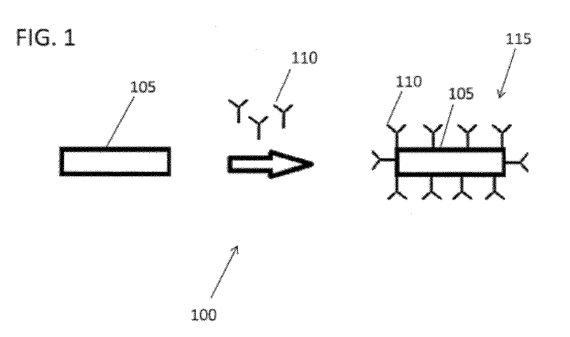

In this study, we prepared a new class of highly toughened epoxy composites from amine-terminated poly(butadiene-acrylonitrile) (ATBN)-modified GO (GA) where the covalently-bonded strong interface plays an important role in fracture characteristics. ATBN chains were grafted onto GO using methylene diphenyl diisocyanate (MDI) as the coupling agent, as illustrated in FIG. 1.

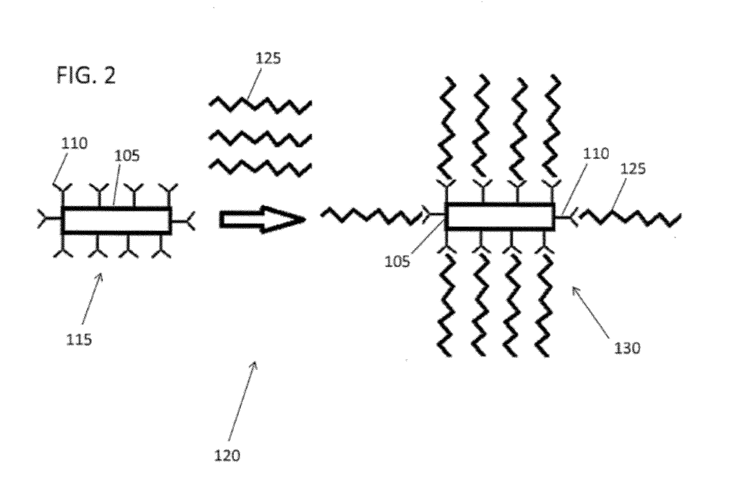

FIG. 2 shows the Fourier transform-infrared (FT-IR) spectra for GO and modified GOs. During the Hummers oxidation of graphite, the conjugated carbon lattice is attacked by strong oxidants, such as potassium permanganate and nitric acid. Structural defects are created subsequently and oxygen-containing groups decorate the surfaces or edges of the nanosheets. Strong O—H absorption bands were observed for GO from 3000 to 3700 cm⁻¹. Peaks corresponding to O—H bending, C═O and C═C stretching vibrations are also clearly seen in FIG. 2. Organic isocyanates were reported to react with the hydroxyl groups on GO, so here di-isocyanate MDI was used to create —NCO groups on GO. The resulting isocyanate-modified GO (GO-NCO) showed an absorption peak corresponding to —NCO groups at 2269 cm⁻¹, indicating the successful grafting of —NCO groups on GO. The weak intensity of the —NCO peak is due to the consumption of —NCO groups by moisture during the preparation of the FT-IR specimen of GO-NCO. In order to avoid the reaction with moisture, GO-NCO was not dried in air, but immediately after washing with dichloromethane it was directly dispersed in dimethylformamide (DMF) for the following reaction with ATBN. The spectrum in FIG. 2 of the resulting GA shows C—H vibrations at 2850 cm⁻¹ and 2920 cm⁻¹ from the grafted ATBN chains. The —NCO signal from GO-NCO disappeared in GA, confirming the reaction between —NCO groups on GO-NCO and the amine groups on ATBN.

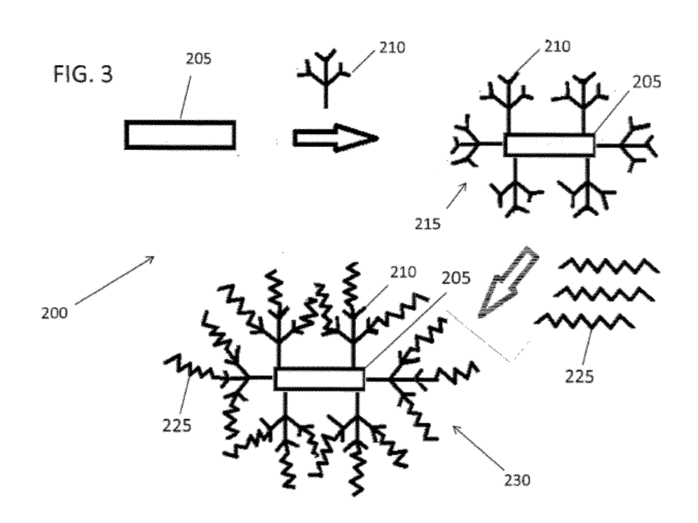

Graphite consists of closely stacked graphene sheets with an interlayer spacing of 0.355 nm. The Hummers oxidation process created hydroxyl and epoxide groups on GO nanosheets, so the d-spacing of GO increased to 0.74 nm, as shown in FIG. 3. After surface modification, the d-spacing increased to 1.10 nm for GO-NCO and 1.38 nm for GA, consistent with the attachment of functional groups to the GO surfaces. The increase in d-spacing from GO to GO-NCO is greater than that from GO-NCO to GA, probably because the molecular structure of the aromatic MDI group is more rigid than the aliphatic ATBN chain.

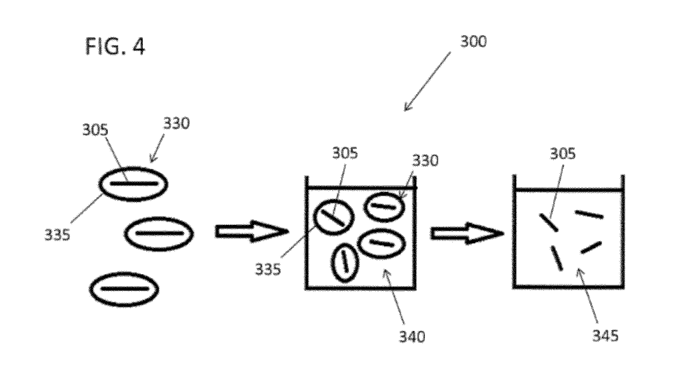

Thermogravimetric analysis (TGA) was used to determine the content of organic functional groups on GA. As shown in FIG. 4, GO displays a major weight loss of 30% from 150° C. to 250° C., which is due to the decomposition of labile surface hydroxyl groups. As for GA, two weight loss processes were observed from the derivative TGA curve. The first weight loss with a derivative TGA peak at 175° C. was assigned to the loss of surface hydroxyl groups, similar to the one in GO. The second weight loss with a broad peak in the derivative TGA curve at 370° C. was assigned to the loss of covalently bonded organic functional groups. The organic content of GA was calculated to be 26.5 wt % from the second weight loss of GA.

2.2. Morphology of Graphene Nanofillers

Besides GO and GA, two grades of pristine graphene nanosheets, GS1 and GS2, were also used in this study and their specifications are listed in Table 2 according to the manufacturer. The morphologies of the graphene nanofillers were characterized by electron microscopy. In transmission electron microscopy (TEM) images in FIG. 5, all the graphene materials are observed as thin nanosheets with sizes of several micrometers. The wrinkled morphology of GS2, GO, and GA is due to the flexibility of the 2D nanosheets. However, fewer wrinkles are observed for GS1 in FIG. 5(a), because the stacking of many graphene layers in GS1 makes it graphite-like and thus more rigid than individual nanosheets.

Bulk morphologies of the obtained graphene powders were revealed by scanning electron microscopy (SEM). The pristine graphene samples, GS1 and GS2, were received as fluffy powders. In FIG. 6, GS1 exhibits a flake-like morphology similar to that seen in the TEM image (FIG. 5(a)), whereas the thin graphene sheets of GS2 have a ball-like morphology due to their high flexibility. As for GO, it is difficult to obtain these powders in bulk form by filtering the GO dispersion, because GO nanosheets block the pores of the membrane filter. Also, by filtration, GO was obtained as a stacked and dense paper, which would be hard to disperse in the amine curing agent. Freeze-drying, a simple and scalable method to separate nanoparticles from their dispersions, was used instead to keep graphene sheets from aggregating. The SEM images of GO and GA after freeze-drying are shown in FIGS. 6(c) and 6(d), respectively. It can be clearly seen that the nanosheets still maintain high aspect ratios, and there is no substantial stacking of the sheets.

2.3. Dispersion of Graphene Nanofillers

Because Jeffamine D230 curing agent is much less viscous than the epoxy resin, graphene nanofillers were first dispersed in the curing agent by ultrasonication. The resulting blends were denoted as D_graphene_x, where x is the graphene weight percentage in the dispersion. All D_graphene dispersions were pourable at room temperature, and they had fluid-like behavior with very low viscosity as shown in FIG. 7. FIGS. 7a and 7b show the viscosity of D230 and graphene dispersions via mixing and ultrasonication as a function of shear rate and shear stress, respectively. With GS1 and GS2, the dispersions showed shear thinning, whereas Newtonian behavior was observed for neat D230 and the dispersions with GO and GA. Shear thinning was the result of swelling of graphene by the D230 and formation of a 3-dimensional network of graphene nanosheets within the D230 matrix, similar to the behavior of clay nanosheets in polyols we have observed previously. The viscosity dramatically increased by addition of the thinner, fewer-layered graphene nanosheets, GS2, dispersions of which showed stronger shear thinning than those with GS1. On the other hand, D230 with GO or GA showed only a small increase in viscosity, indicating that these nanofillers were not exfoliated but remained in the form of thick layered stacks.

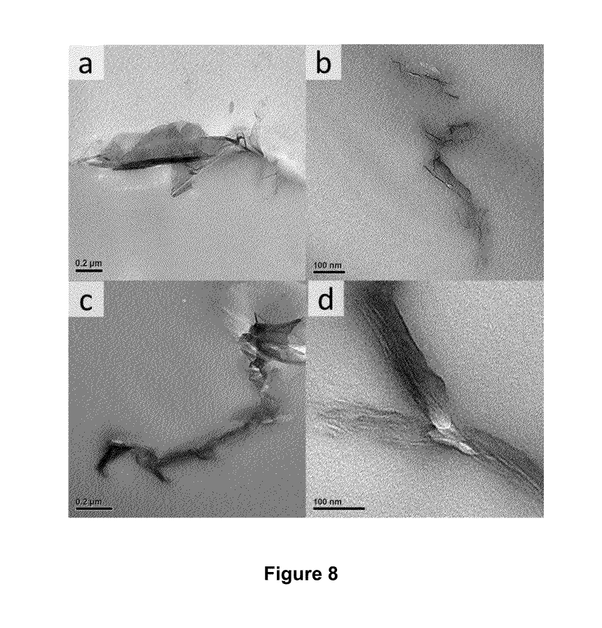

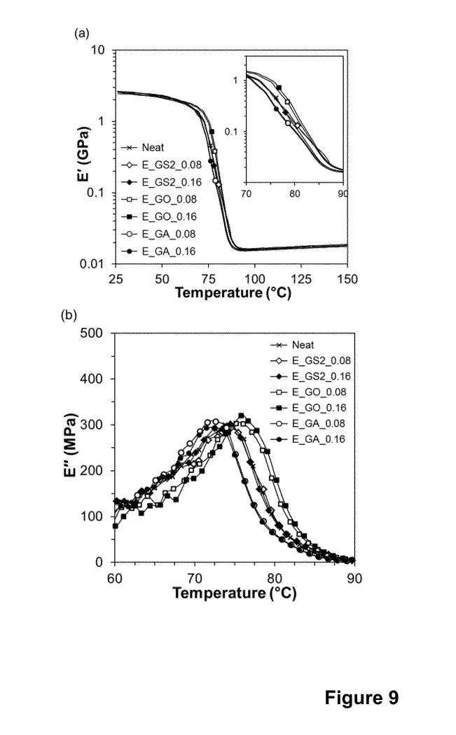

The dispersion state of graphene nanofillers in the final epoxy polymer is greatly affected by the compatibility between epoxy/amine and the surface of different graphene materials. The final nanocomposites were denoted as E_graphene_y, where y is the graphene weight percentage in the nanocomposite. For example, the D_graphene_{—}1.16 dispersion was mixed with epoxy resin at a D230:epoxy resin weight ratio of 35:100 to make the final composite, E_graphene_{—}0.30. The TEM images in FIG. 8 illustrate the state of dispersion of nanofiller particles in the epoxy matrix. Good dispersions of high-aspect-ratio graphene nanosheets can be observed for E_GS1 (FIG. 8(a)) and E_GS2 (FIG. 8(b)). The thickness values of typical nanosheets were ca. 15 nm and 3 nm for GS1 and GS2, respectively, on the basis of TEM images. Similar to the TEM images of pristine graphenes (FIG. 6), GS1 displays less corrugation than GS2 due to the high rigidity of the multilayered nanosheets. Despite the good dispersity of GO in water, the dense stacking of GO nanosheets is clearly seen in E_GO even after intense ultrasonication treatment (FIG. 8(c)). The aggregation of GO nanosheets resulted from the unmatched surface properties between hydrophilic GO and the D230/epoxy matrix. After modification with ATBN, intercalation and exfoliation of GA was observed in E_GA (FIG. 8(d)). Typical thicknesses of GO and GA sheets in the nanocomposites are ca. 30 nm and 10 nm, respectively, estimated from TEM.

2.4. Thermo-Mechanical Properties and Fracture Toughness of Epoxy Nanocomposites

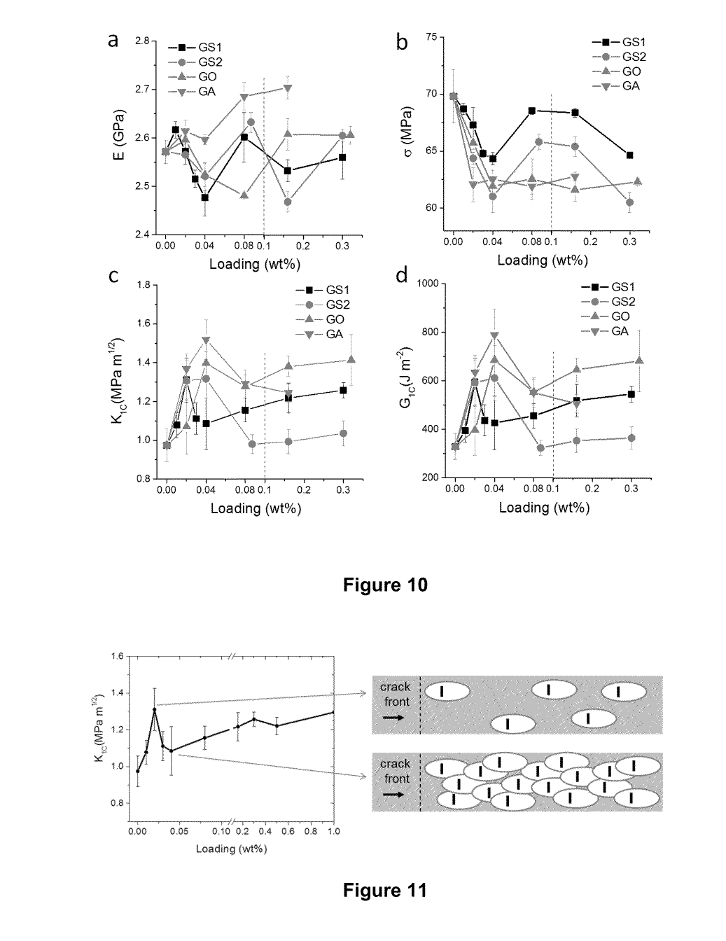

Modulus and strength of the epoxy/graphene nanocomposites are shown in FIG. 10. The moduli of epoxy nanocomposites with pristine graphenes fluctuate as a function of graphene contents from 0.01 to 0.3 wt %. The insignificant effect of pristine graphenes on modulus change is due to the weak epoxy-graphene interface, resulting from the inert graphene lattice on the surface of GS1 and GS2. E_GO also displayed negligible change in modulus compared to the neat epoxy, because of the aggregation of GO nanosheets in the epoxy matrix. A slight increase in modulus was observed for E_GA and was attributed to the good dispersion of GA nanosheets as well as the covalently bonded GA/epoxy interface. Flexural and tensile modulus data vs graphene loading fit the Mori-Tanaka model. All the epoxy nanocomposites showed a slight decrease in tensile strength, which is commonly observed for polymer nanocomposites with stiff nanofillers. However, overall the mechanical modulus and strength of the epoxy matrix are not highly responsive to the incorporation of graphene nanofillers.

Graphene nanofillers have a more significant impact on the fracture toughness and fracture energy of the epoxy matrix, as shown in FIGS. 10(c) and 10(d). Crack-opening tests on compact tension samples were performed to measure the mode-I critical stress intensity factor (K_{1c}, fracture toughness) and critical strain energy release rate (G_{1c}, fracture energy) of the pure epoxy matrix and E_GS, E_GO and E_GA nanocomposites at various weight fractions of graphenes. The K_{1c} of the neat epoxy, 0.97 MPa m^{1/2}, is in good agreement with other neat epoxy polymers in previous studies. For E_GS1, the K_{1c} increased by 35% with only 0.02 wt % of graphene loading, compared to the base value of the epoxy. A sharp decrease of K_{1c} was observed at 0.04 wt % of graphene loading, which was followed by a trend of slow increase upon higher graphene loadings (also in FIG. 11). Surprisingly, similar peak behavior in the toughening effect can also be seen in FIG. 10(c) for the composites with other graphene nanofillers at 0.02 wt % or 0.04 wt % graphene loading, and the maximum improvements of K_{Ic} were 32%, 40% and 52% for E_GS2, E_GO and E_GA, respectively. The best performance of E_GA is attributed to the good dispersion of GA and the strong epoxy-GA interface in the nanocomposites. Correspondingly, E_GA displayed a maximum 2.4-fold improvement in G_{1c} at 0.04 wt % of graphene loading. A maximum in epoxy toughening at small graphene loadings was reported in a previous study on graphene-based epoxy composites, but at a larger graphene loading (>0.1 wt %) than those shown here. In contrast, continuous toughening with the increase of graphene loading was reported in several other studies, but they required at least 10-times higher loadings of graphene to obtain the improvement in K_{1c} or G_{1c} achieved in this study.

2.5. Toughening Mechanism at Small Graphene Loadings

The failure of polymers is a very complicated process and involves the loss of structural integrity at microscopic and macroscopic levels under deformation. The intrinsic brittleness of neat epoxy polymers results in catastrophic fracture because of the lack of energy-absorbing events during the crack propagation. Inclusion of a secondary rubbery phase in the crosslinked structure has shown great effectiveness, because the yielding of the rubbery phase during debonding with the matrix can dissipate a significant amount of energy leading to an increase in the toughness. However, for epoxies filled with inorganic particles, due to the high rigidity of the filler particles, the toughening mechanism involves the plastic yielding of the matrix around particles and subsequent void formation, as well as the interference of rigid particles during crack propagation, such as crack deflection and crack pinning (schematic illustrations in FIG. 16). When the crack front encounters a rigid particle, the crack plane can be deflected by tilting or twisting, and thus a larger crack area results compared to undeflected propagation. The crack tip can also be pinned by the particulate obstacles, and thus the crack length will be increased. Tails are usually formed behind the particles before the unification of the pinned crack into the primary crack plane, contributing to an increase in fracture line energy. Rigid fillers act as stress concentrators; the localized stress field surrounding a filler particle may form a microcrack zone and cause debonding between the particle and the matrix. Thus a microvoid forms around the particle in front of the crack tip opening, initiating the secondary crack propagation. Various studies have proposed that crack pinning and debonding effects are the two main mechanisms contributing to the overall toughening effect.

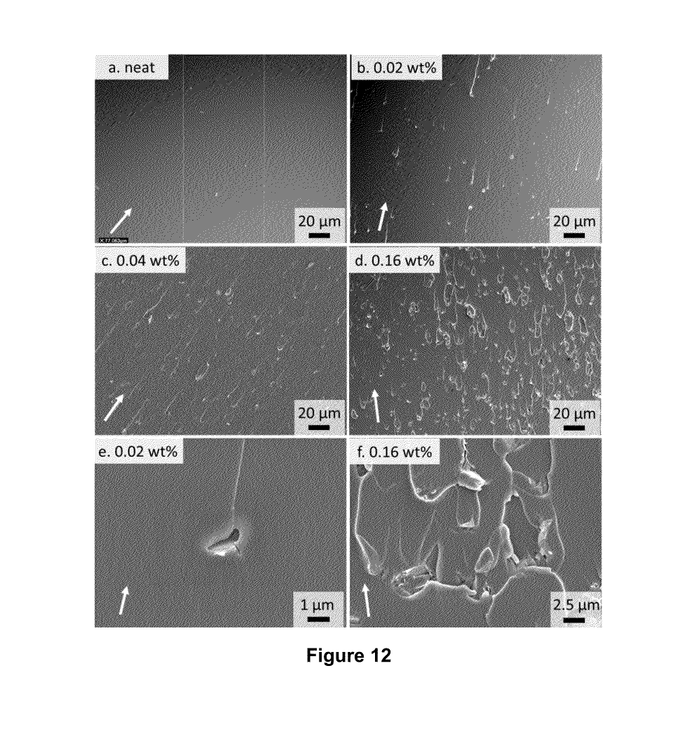

SEM fractography was employed to investigate the fracture mechanism. The fractographs of neat epoxy and E_GS1 with different graphene loadings are shown in FIG. 12. The neat epoxy displayed a very smooth fracture surface, and almost no events were observed during the crack propagation due to the brittleness of the matrix. After incorporation of GS1, some geometric markings were seen on the fracture surface. The “tail” morphology indicates that the marking was generated by crack pinning involving rigid GS1 particles. From the high magnification image in FIG. 12(e), microcracks were also observed around the particles, indicating the debonding between the graphene and the matrix. The amount of crack pinning and microcracks increased with higher GS1 loading (FIGS. 12(c) and 12(d)). At 0.16 wt % of GS1 loading, because of the short interparticle distances, the microcracks could be pinned again before they were unified into the primary crack. The crack deflection, pinning, and the coalescence of microcracks resulted in a very rough surface.

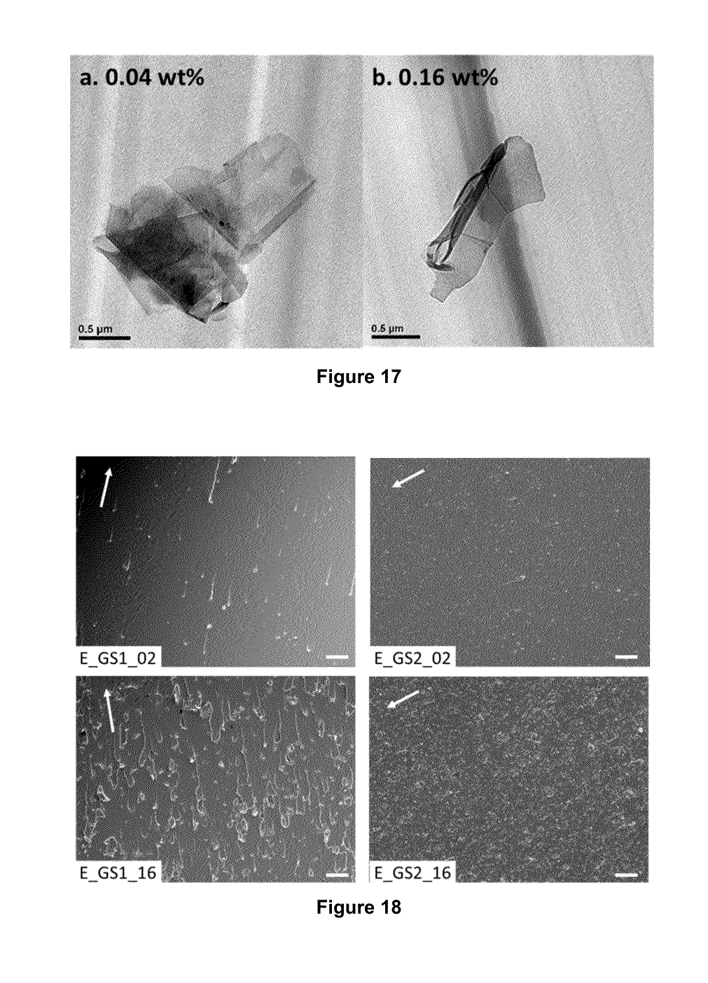

It is clear that at higher graphene loadings, crack deflection and crack pinning increase accordingly, which should result in an increase in fracture toughness. In our study, however, a peak in K_{1c} at a small graphene loading was observed, followed by a decrease and then a slow increase of K_{1c}. In a previous study, it was suggested that crack deflection was the main mechanism for the peak of K_{1c} at small graphene loadings, and the subsequent decrease of K_{1c} was attributed to the aggregation of graphene. However, more crack deflections occurred in the composites with higher graphene loadings, and no significant aggregation of GS1 was observed in the composite with a higher loading (FIG. 17). In fact, preformed microvoids in epoxy with rigid plastic particles were reported to show toughening effects similar to rubber tougheners. On the other hand, if the microcrack zones are close to each other, the coalescence of microcracks may facilitate a major crack propagation. Therefore, we propose that microcrack formation contributes most to the maximum toughening at small graphene loadings, as shown in FIG. 11. As the graphene loading increases, crack pinning and crack deflection become more important in the epoxy toughening. In this case, the trend for the increase in K_{1c} on the graphene loading is less steep because the coalescing of microcracks may facilitate the propagation of the primary crack.

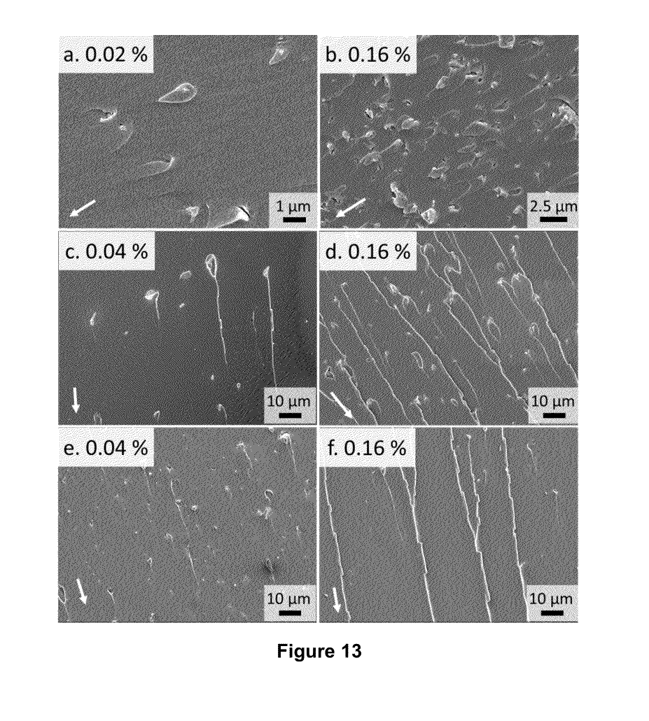

GS2 nanosheets are similar to GS1 in structure but much thinner. From FIG. 13(a) we can see that the tails around the particles in E_GS2 are much shorter than those in E_GS1, possibly because thin GS2 sheets can be easily broken, and thus are not able to induce as effective microcrack formation and crack pinning as GS1. However, the number of GS2 particles is much greater than that of GS1 in the composite with the same graphene loading (FIG. 18), so E_GS2 still exhibits significant toughening at graphene contents of 0.02 and 0.04 wt %. The coalescence of secondary microcracks in E_GS2 should follow a similar manner to that in E_GS1, causing the decrease of K_{1c} after 0.04 wt %. With 0.16 wt % graphene, the surface roughness of E_GS2 is much less than that of E_GS1, indicating a lower K_{1c} (FIG. 10(c)).

According to the proposed microcrack mechanism for the epoxy toughening at small graphene loadings, if the energy consumption for the microcrack formation is higher, then higher fracture toughness should be observed. For E_GO and E_GA, the functional groups on GO and GA can induce a reaction between epoxy and graphene fillers during the curing process. The interfacial covalent bonding increases the energy dissipation to form microcracks, and therefore the corresponding composites exhibit higher fracture toughness than composites with pristine graphene. For E_GA, because the grafted rubber chain can further store elastic energy, the highest fracture toughness is observed. The interfacial bonding also affected the morphology at higher graphene loadings. In FIGS. 13(d) and 13(e), E_GO and E_GA displayed a pattern with stretched lines throughout the fracture surface, rather than a random coalescence of microcracks observed in the composites with pristine graphenes. Due to the covalent tethering to the filler particle, the epoxy matrix may undergo plastic yielding around GO or GA. During crack propagation, the matrix surrounding the graphene is pulled out to form the stretched lines in the same direction of crack propagation. The higher K_{1c} values of E_GO compared to E_GS1 may be ascribed to the absence of significant coalescence of microcracks and the increase of the fracture line energy.

3. Conclusion

In this study, four types of graphene nanosheets were incorporated into an epoxy matrix via a facile, solvent-free route. GO was modified with ATBN molecules to improve the dispersion in epoxy and increase the interfacial strength. Good dispersions of graphene in the nanocomposites were demonstrated by TEM, except that stacking of GO nanosheets was observed in the nanocomposites. An impressive toughening effect was observed for nanocomposites with less than 0.1 wt % of graphene, and epoxy composites with GA showed a 1.5-fold improvement in K₁ and a corresponding 2.4-fold improvement in G₁ at 0.04 wt % of graphene loading. No other study in the literature has achieved such high toughness at this low loading. Interestingly, all the composite systems showed a toughness peak at loadings as small as 0.02 or 0.04 wt %. From SEM fractography observations a microcrack-crazing mechanism was proposed to explain the fracture results. Due to the significant improvement in toughness at such small loading levels, this functionalized graphene approach is economically attractive.

4. Experimental Section

Materials: The following materials were used as received: Epon 828 epoxy resin (MW ˜377 g mol⁻¹, Momentive), Jeffamine D230 curing agent (MW=250 g mol⁻¹, Huntsman), 4,4′-methylene diphenyl diisocyanate (98%, Sigma-Aldrich), NaNO₃ and KMnO₄ (Fisher Scientific), concentrated H₂SO₄ and HCl (VWR International), H₂O₂ (30%, Macron Fine Chemicals). Two grades of pristine graphene nanosheets (Angstron Materials, see Table 2) were dried under vacuum at 70° C. overnight before use. Natural graphite flakes (SP-1, 45 μm, Bay Carbon) were used to prepare graphene oxide. Hycar 1300X42 primary amine-terminated poly(butadiene-acrylonitrile) (MW=900 g mol⁻¹, Emerald Performance Materials) was also dried under vacuum before functionalization of graphene oxide. Dimethylformamide and dichloromethane were dried with molecular sieves before use.

Preparation of Graphene Oxide:

GO was synthesized from natural graphite according to the Hummers method as reported elsewhere. After the oxidation, excess oxidant was removed by washing with H₂O₂ solution (30 wt %), and the resulting slurry was centrifuged and washed with 2 M HCl until it was SO₄² free as tested by 0.1 M BaCl₂ solution. Then the brown dispersion was dialyzed several times in deionized water until the pH reached a value of ˜3 and remained unchanged. The pH of the GO dispersion was adjusted to around 6 with ammonia, and then bath sonication was used to aid the exfoliation of GO. GO was obtained as a powder by freeze-drying the dialyzed solution and further drying in a vacuum oven at 60° C. overnight.

Preparation of ATBN-Modified GO:

ATBN chains were grafted onto GO by using MDI as the coupling agent, as illustrated in FIG. 1. First, 200 mg of GO were dispersed in 50 mL of DMF by bath sonication. The dispersion was purged with nitrogen for 30 min, followed by addition of 4 g of MDI. The reaction was carried out in an oil bath at 60° C. for 24 h, and then the mixture was flocculated by adding dichloromethane. The solid product was washed with dichloromethane at least five times to remove any excess MDI. The centrifuge tubes were sealed with parafilm to minimize exposure to moisture from the air. GO-NCO was dispersed in 100 mL of DMF without drying. After bath sonication, 20 g of 10 wt % ATBN in DMF was added while stirring. The reaction was carried out at 60° C. with nitrogen purging for two days. Acetone was used to flocculate the mixture, and the solid product was collected by centrifugation. After washing with acetone at least five times, GA was redispersed in tert-butanol, which was then freeze-dried. GA was obtained as a powder after freeze-drying further drying in a vacuum over at 60° C. for 6 h.

Synthesis of Epoxy/Graphene Nanocomposites:

The desired amount of graphene nanofillers was first weighed and dispersed in Jeffamine D230 using an ultrasonic probe sonicator (Misonix 54000 with 0.25″ microtip) for 3 h (90° C. for GS1 and GS2, 70° C. for GO and GA). After the D230-graphene dispersion had cooled down to room temperature, it was added to Epon 828 epoxy resin, and the mixture was mechanically stirred with a Cowles blade at 700 rpm for 2 min and then 300 rpm for 15 min. The amounts of epoxy resin and amine curing agent were 100 and 35 parts by weight, respectively. Next, the mixture was degassed for 15 min in a vacuum oven, followed by pouring into glass molds. The nanocomposites were obtained after curing at 60° C. for 2 h and 120° C. for another 12 h.

Characterization:

Fourier transform-infrared spectroscopy was carried out using a Nicolet Magna-IR 760 spectrometer. X-ray diffraction patterns were acquired using a PANalytical X-Pert Pro MPD X-ray diffractometer equipped with a Co source (45 kV, 40 mA, π=0.179 nm) and an X-Celerator detector. Transmission electron microscopy images were obtained on a FEI Tecnai T12 microscope using an accelerating voltage of 100 kV. Graphene samples were picked up on carbon-coated Cu grids from dispersions. Polymer samples were first microtomed (Leica Ultracut) at room temperature into 70 nm thick sections before being picked up on Cu grids. Thermogravimetric analyses were carried out with a Netzsch STA 409 PC instrument in flowing nitrogen using a ramping rate of 10° C. mim⁻¹. Scanning electron microscopy images were taken using a JEOL 6500 FEG-SEM with an accelerating voltage of 5 kV. Samples were mounted on Al stubs, and a 5 nm Pt coating was applied on insulating samples.

Rheological characteristics of the curing agent/graphene blends were measured using a AR-G2 (TA Instruments) rotational rheometer with a 40 mm cone plate at room temperature. Viscosity profiles were obtained under steady state flow as the shear rate was increased in logarithmic increments from 0.1 to 1000 s⁻¹. Thermo-mechanical properties of E_graphene composites were studied with a dynamic temperature ramp from 25 to 150° C. (ramping rate=5° C. min⁻¹) using a RSA-G2 solids analyzer (TA Instruments). 3 mm wide and 4 cm long rectangular strips cut from the cured plates were dried in vacuum at room temperature and mounted between tensile fixtures. Dynamic tensile storage and loss moduli were measured at 1 rads⁻¹. During each test, static pretension on the specimens was maintained at a frequency of 1 Hz under a dynamic strain of 0.004% with a pretension of 50 g force. DSC measurements were carried out with a TA Instruments DSC Q1000. A sample mass of 5 mg was loaded into an aluminum pan and scanning was performed from −10° C. to 200° C. at a rate of 10° C. min⁻¹ after removing the thermal history with 5 min heating at 200° C. The T_{g} determination was based on the inflection point method using TA Universal Analysis software.

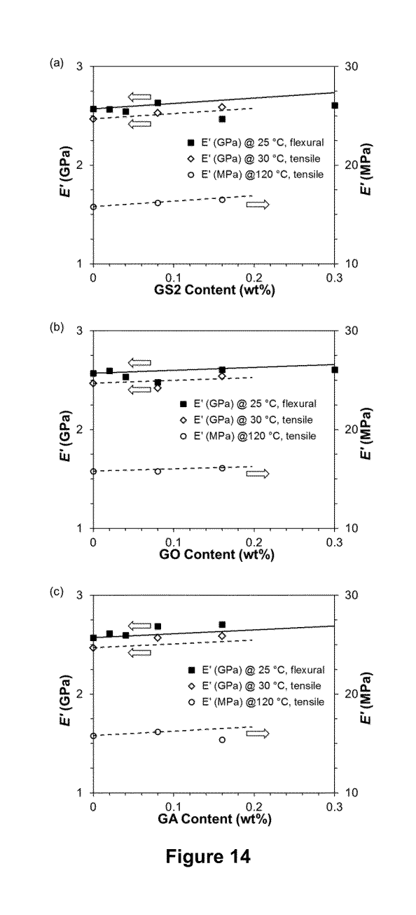

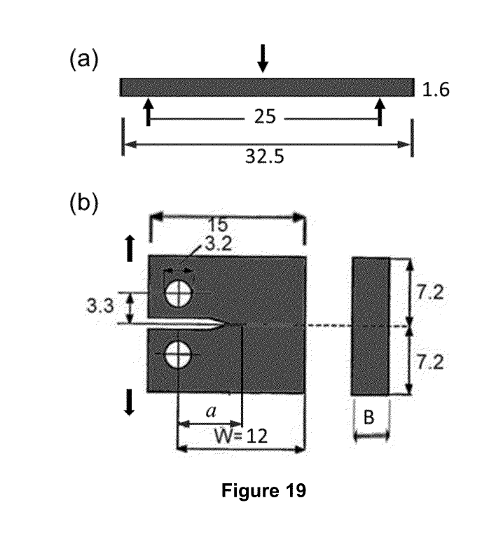

For mechanical testing, samples were cut into specimens with specific geometries as shown in FIG. 19. Flexural modulus and strength were measured using an RSA-G2 solids analyzer (TA Instruments) according to ASTM D790-10 at a span-to-thickness ratio of 16 and a crosshead rate of 0.25 mm min⁻¹ (0.01 min⁻¹ strain rate). Fracture behavior was measured with crack-opening tests on compact tension specimens according to ASTM D5045-99. A precrack with an average length of 2±0 6 mm was initiated by tapping a fresh liquid-N₂-chilled razor blade into the notch. Specimens were loaded to failure at 10 mm min⁻¹ using an Instron 3344 single column testing system equipped with a 5 kN load cell. At each weight fraction of graphene additives, we tested 15 different samples to check for reproducibility of the results, and then the mode-I critical-stress-intensity factor (K_{1c}) and critical strain energy release rate (G_{1c}) were calculated based on Equation 1 and 3, respectively. The mode-I critical-stress-intensity factor is defined as

$${K}_{Ic} = \frac{{P}_{Q}}{B \sqrt{W}} f ( x ) \qquad ( 1 )$$

where P_{Q} is the maximum loading force in the compact-tension test, B and W are sample thickness and characteristic length of the specimen, respectively, as defined in FIG. 14. f(x) is the geometric factor, defined as

$$f ( x ) = \frac{( 2 + x ) ( 0.866 + 4.64 x - 13.22 {x}^{2} + 14.72 {x}^{3} - 5.6 {x}^{4} )}{{( 1 - x )}^{3 / 2}} \qquad ( 2 )$$

where x=a/W and a is the initial notch length including the precrack.

The mode-I critical strain energy release rate is defined as

$${G}_{Ic} = \frac{( 1 - {v}^{2} ) {K}_{Ic}^{2}}{E} \qquad ( 3 )$$

where E is the elastic modulus and v is the Poisson ratio of the epoxy, which is taken to be 0.34.

TABLE 2
Specifications of pristine graphene
nanosheets from the manufacturer.

| Nota- | Product | Thick- | | | Oxygen | Surface | |
|---|---|---|---|---|---|---|---|
| tion | name | ness | | Size | content | area | |
| GS1 | N006-P | 10-20 | nm | ~14 μm | 1.5% | ≦21 | m² g⁻¹ |
| GS2 | N002-PDR | <1 | nm | ≦10 μm | 2.1% | 400-800 | m² g⁻¹ |

TABLE 3
Graphene weight fraction, glass transition temperatures, T_{g}, from DSC analysis,
E″ peak and tan δ peak temperatures, and storage tensile moduli, E′, from
DMA, of neat epoxy and epoxy/graphene nanocomposites

| | Filler | DMA | | | | DSC |
|---|---|---|---|---|---|---|
| | content | E′ at 30° C. | E′ at 100° C. | T_{g} by max E″ | T_{g} by max tan δ | T_{g} |
| Sample | (wt %) | (GPa) | (MPa) | (° C.) | (° C.) | (° C.) |
| E_Neat | 0 | 2.47 | 15.8 | 73.8 | 83.1 | 70.6 |
| E_GS2 | 0.08 | 2.53 | 16.2 | 74.6 | 84.2 | 76.8 |
| | 0.16 | 2.59 | 16.5 | 74.4 | 85.0 | 77.8 |
| E_GO | 0.08 | 2.42 | 15.8 | 76.1 | 84.2 | 81.2 |
| | 0.16 | 2.54 | 16.1 | 76.7 | 83.7 | 80.9 |
| E_GA | 0.08 | 2.57 | 16.2 | 72.6 | 83.2 | 78.5 |
| | 0.16 | 2.59 | 15.4 | 72.5 | 83.1 | 71.9 |

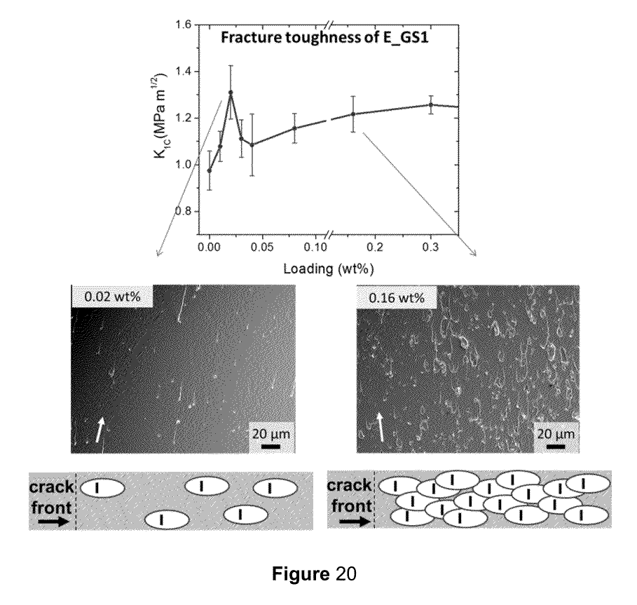

Epoxy toughening by graphene is demonstrated at graphene loadings as low as 0.02 wt %. Functionalization of graphene can further improve the toughening effect at such a small loading level. A mechanism based on the formation and coalescence of microcracks generated by graphene is proposed to explain the fracture behavior of epoxy/graphene nanocomposites. This concept is illustrated by FIG. 20.

### Additional Supporting Information

### Mori-Tanaka Model for Nanocomposite Tensile Moduli and Material Parameters

The model of Mori and Tanaka (T. Mori, K. Tanaka, Acta Metall. 1973, 21, 571) was modified by Tandon and Weng (G. P. Tandon, G. J. Weng, Polym. Compos. 1984, 5, 327) for calculation of the modulus E₁₁ of composites containing mono-dispersed ellipsoids with perfect planar orientation:

$$\frac{{E}_{11}}{{E}_{m}} = \frac{1}{1 + {φ}_{p} ( - 2 {v}_{m} {A}_{3} + ( 1 - {v}_{m} ) {A}_{4} + ( 1 + {v}_{m} ) {A}_{5} A ) / 2 A}$$

where φₚ is the particle volume fraction, Eₘ and vₘ are the Young's modulus and Poisson's ratio of the matrix, respectively, A and Aᵢ can be calculated from the matrix and particle properties and components of the Eshelby tensor (J. D. Eshelby, Proc. Roy. Soc. (London) 1957, 241, 376), which depend on the particle aspect ratio and elastic constants of the matrix (see the detailed formula in G. P. Tandon, G. J. Weng, Polym. Compos. 1984, 5, 327). To calculate φₚ a density of 2.0 g/cm³ was assumed. Eₘ is the experimental modulus of the neat epoxy and Poisson's ratio vₘ=0.34. E_{graphene} is assumed to be the value reported for graphene oxide, 250 GPa, and V_{graphene}=0.006. (C. Gómez-Navarro, M. Burghard, K. Kern, Nano Lett. 2008, 8, 2045 and J. W. Suk, R. D. Piner, J. An, R. S. Ruoff, ACS Nano 2010, 4, 6557). The remaining unknown is the particle aspect ratio which was obtained from the linear fits shown in FIG. 14. These values are consistent with dimensions estimated from the TEM images in FIG. 8 which are tabulated in Table 4 below.

TABLE 4
Typical dimensions of the nanoparticles
dispersed in the epoxy matrices.

| System | Length, L (nm) | Thickness, t (nm) | Aspect ratio, L/t |
|---|---|---|---|
| E_GS2 | 300 | 3 | 100 |
| E_GO | 1200 | 30 | 40 |
| E_GA | 600 | 10 | 60 |

FIG. 14 shows experimental and theoretical modulus data for epoxy nanocomposites with each graphene: Mori-Tanaka theoretical predictions were estimated with (a) GS2 (aspect ratio of 100), (b) GO (aspect ratio of 40), and (c) GA (aspect ratio of 60) in the exfoliated state, respectively.

### 3-Point-Bending and Compact-Tension Test Plots

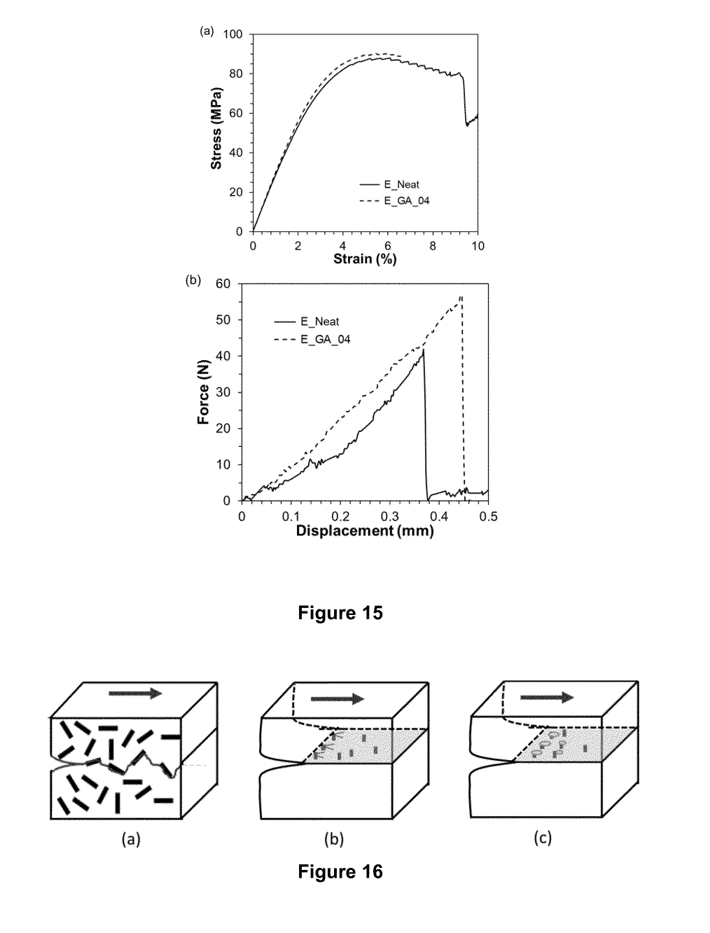

FIG. 15 shows representative plots of (a) 3 point-bending data for flexural modulus and strength and (b) compact tension tests for fracture toughness. In compact tension tests, both samples had the same crack length of a=6.09 mm.

### Schematics of Proposed Toughening Mechanisms

FIG. 16 shows toughening mechanisms in rigid particle-filled epoxies: (a) crack deflection, (b) crack pinning, (c) microcrack formation. The direction of crack propagation is indicated by the red arrow.

### TEM and SEM Images

FIG. 17 presents TEM images of E_GS1_{—}04 and E_GS1_{—}16. No significant aggregation of graphene particle was observed.

FIG. 18 presents SEM fractographs of E_GS1 and E_GS2 with 0.02 and 0.16 wt % graphene loadings. White arrows indicate the crack propagation direction. Scale Bar: 20 μm.

### Description of Samples for Mechanical Testing

FIG. 19 shows the three-point bending and compact tension specimens. The span length at bending tests was 25 mm and sample width was 10 mm. For the compact tension specimens the length of the precrack was limited by 0.45<a/W<0.55.

### Additional Embodiments

1.) Modification of Graphene Oxide/Graphite Oxide with TMI Isocyanate (TMI-GO)

This functionalization was undertaken to facilitate the dispersion of GO into the unsaturated polyester (UP) matrix and to improve the adhesion between the matrix and filler via covalent bonding. To understand how these advantages are realized, a more detailed description of the functionalization needs to be given. The commercially-available TMI isocyante is covalently anchored onto the GO via reactions between the isocyanate and epoxides/hydroxyl functional groups on the surface of the GO. Once the covalent linkages are formed (either amides or urethanes), the surface of the GO is decorated with α-methylstyrene functionalities from the TMI isocyanate. Methylstyrene is similar in structure to the styrene reactive diluent, and the presences of this functional group aids in the dispersion of the functionalized GO in the diluted resin. In addition, the double bond present on the α-methylstyrene can participate in the free-radical polymerization that occurs during gelation/curing of the UP resin. These covalent bonds between the filler and the matrix improve the fracture toughness. The double bond functionality present on the methylstyrene can potentially be used to graft longer chain polymers on the GO, as well.

2.) Dual Modification of Graphene Oxide/Graphite Oxide with TMI Isocyanate and then an Aliphatic Amine

While the TMI-functionalization described above does assist in the dispersion, a secondary functionalization can be used to greatly facilitate filler dispersion in the UP resin. Extant epoxy functional groups on the TMI-GO can react with primary alkylamines under the reaction conditions specified in the examples. After this functionalization, the new GO material contains both methylstyrene and alkyl functionalities. By adjusting various parameters (including alkyl chain length), it is possible to disperse the GO in the UP resin in less than an hour using only mechanical stirring. Some functionalizations also allow for the formation of dispersions that are stable for at least several weeks. Enhanced adhesion to the resin matrix is also possible through the double bonds still present on the methylstyrene functionalities.

Graphene oxide is generally used to refer to single sheets of exfoliated graphite oxide present in a dispersion, composite, or free-standing material. Graphite oxide generally refers to materials that contain stacked graphene oxide sheets.

### Examples 21-22

### TMI-GO-40° C.-1x and TMI-GO-25° C.-1x

In a sealed glass vessel, 100 mg of graphite oxide and 25 mL of anhydrous n,n-dimethylformamide were stirred for 15 minutes. This mixture was then agitated in an ultrasonic bath for 1 hour. The mixture was transferred to a round bottom flask (RBF) and placed in an oil bath set at 40° C. for TMI-GO-40 C-1x or 25° C. for TMI-GO-40° C.-1x. A flow of nitrogen gas was used to continually purge the head space of the RBF. Magnetic stirring of the mixture was maintained at 300 RPM. After 2 hours of purging, 1 mL of 3-isopropenyl-α,α-dimethylbenzyl isocyanate (TMI isocyanate) was injected into the RBF. The mixture was then heated and stirred for 24 hours. This was then quenched using 100 mL of dry toluene.

Functionalized graphite oxide was separated from the other components of the reaction mixture by centrifugation. Portions of the quenched reaction mixture were spun down at 3000 RPM for 30 minutes. The supernatant was then removed. Three additional washing steps were conducted. For each step, toluene was added, the suspension was spun at 3000 RPM for 30 minutes, and the clear (or light brown) supernatant was removed. After the last toluene washing step, tert-butanol was added to the pellets and the mixture was spun down for 15 minutes at 3000 RPM. The tert-butanol was removed and an additional portion was added. This suspension was spun down for 15 minutes at 3000 RPM, the supernatant was removed, and the pellets were frozen in a cryogen. These pellets were then evacuated in low vacuum (˜0.01 torr) for 24 hours, which allowed for the sublimation of any remaining tert-butanol. Brown powders TMI-GO-40° C.-1x or TMI-GO-25° C.-1x (depending on the reaction conditions) were obtained after the freeze-drying process.

### Examples 23-24

### TMI-GO-60° C.-2x-D and TMI-GO-60° C.-2x-Sn

In a sealed glass vessel, 100 mg of graphite oxide, 25 mL of anhydrous n,n-dimethylformamide and 5 mg of 1,4-diazabicyclo[2.2.2]octane (DABCO) were stirred for 15 minutes for synthesis of TMI-GO-60° C.-2x-D. Alternately, 100 mg of graphite oxide, 25 mL of anhydrous n,n-dimethylformamide and 5 mg of dibutyltindilaurate (DBTDL) for synthesis of TMI-GO-60° C.-2x-Sn. This mixture was then agitated in an ultrasonic bath for 1 hour. The mixture was transferred to a round bottom flask and placed in an oil bath set at 60° C. A flow of nitrogen gas was used to continually purge the head space of the RBF. Magnetic stirring of the mixture was maintained at 300 RPM. After 2 hours of purging, 2 mL of 3-isopropenyl-α,α-dimethylbenzyl isocyanate (TMI isocyanate) was injected into the RBF. The mixture was then heated and stirred for 24 hours. This was then quenched using 100 mL of dry methylene chloride.

Functionalized graphite oxide was separated from the other components of the reaction mixture by centrifugation. Portions of the quenched reaction mixture were spun down at 3000 RPM for 30 minutes. The supernatant was then removed. Three additional washing steps were conducted. For each step, methylene chloride was added, the suspension was spun at 3000 RPM for 30 minutes, and the clear (or light brown) supernatant was removed. After the last washing step, tert-butanol was added to the pellets and the mixture was stirred down for 15 minutes at 3000 RPM. The tert-butanol was removed and an additional portion was added. This suspension was spun down for 15 minutes at 3000 RPM, the supernatant was removed, and the pellets were frozen in a cryogen. These pellets were then evacuated in low vacuum (˜0.01 torr) for 24 hours, which allowed for the sublimation of any remaining tert-butanol. Brown powders of TMI-GO-60° C.-2x-D and TMI-GO-60° C.-2x-Sn (depending on the catalyst used in the synthesis) were obtained after the freeze-drying process.

### Example 25

### TMI-GO-60° C.-2x-D-Stearyl

In a sealed glass vessel, 100 mg of the TMI-GO-60° C.-2x-D, 50 mL of anhydrous n,n-dimethylformamide, and 400 mg of octadecylamine (stearylamine) were stirred for 15 minutes. This mixture was then agitated in an ultrasonic bath for 1 hour. If visible pieces of solid octadecylamine were still present in the mixture, an addition 1 hour of sonication was conducted. The mixture was transferred to a round bottom flask and the head space was continually purged with a flow of nitrogen. The round bottom flask was immersed in an oil bath heated to 70° C. and stirred at 300 RPM using a magnetic stir bar. Heating and stirring was maintained for 24 hours and then the reaction was quenched with 150 mL of 200 proof ethanol.

The graphite oxide was separated from the other components of the reaction mixture by centrifugation. Portions of the quenched reaction mixture were spun down at 3000 RPM for 30 minutes. The supernatant was then removed. Two additional washing steps were conducted. For each step, ethanol was added, the suspension was spun at 3000 RPM for 30 minutes, and the clear supernatant was removed. After the last washing step, tert-butanol was added to the pellets and the mixture was stirred down for 15 minutes at 3000 RPM. The tert-butanol was removed and an additional portion was added. This suspension was spun down for 15 minutes at 3000 RPM, the supernatant was removed, and the pellets were frozen in a cryogen. These pellets were then evacuated in low vacuum (˜0.01 torr) for 24 hours, which allowed for the sublimation of any remaining tert-butanol. Black powders TMI-GO-60° C.-2x-D-Stearyl were obtained after the freeze-drying process.

This synthesis is not limited to the use of octadecylamine. Other alkylamines (including dodecylamine and octylamine) can be utilized for the functionalization in the same fashion as described for example 5.

### Example 26

### Laminate Examples

### Laminate Constructs

1. Laminate Preparation

Two sets of glass fiber-reinforced laminates were prepared with two different types of E-glass fabrics, unidirectional (11.5 oz/sq. yd.) or woven roving (18 oz/sq. yd.). For each reinforcement type, one laminate was infused with neat AROPOL 8422 resin (unsaturated polyester) while the other had 0.04 wt % TMI-GO_{—}60° C._{—}2x_D loaded into the resin. To reach the thickness recommended by ASTM 5528 for interlaminar fracture toughness, ten plies of unidirectional fabric and six plies of woven roving were used. At the midplane of each laminate, a thin PTFE film (˜0.001″ thick, 13″ long, and 3.5″ wide) was inserted to act as a crack starter during testing. The two woven roving laminates had dimensions of 13″ long by 13″ wide by 0.10″ thick. The two unidirectional laminates had dimensions of 13″ long by 9″ wide by 0.14″ thick.

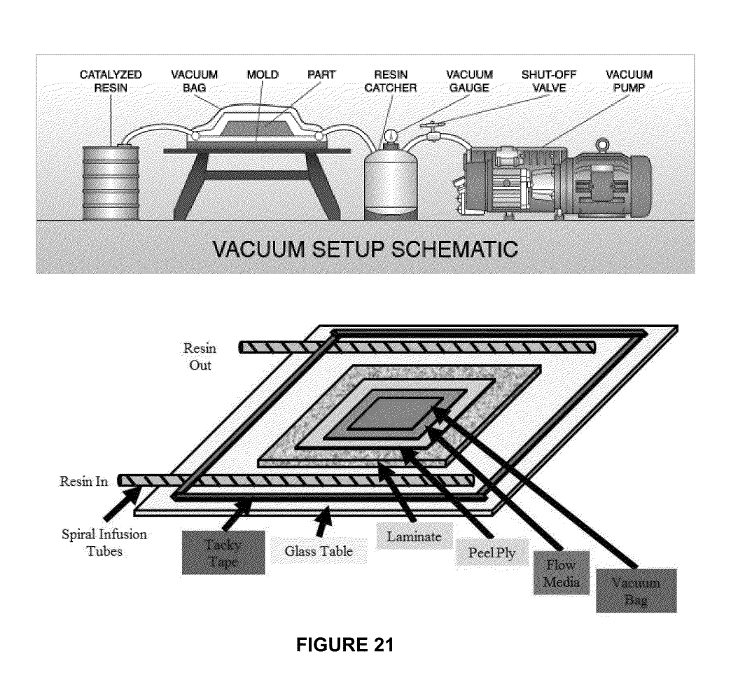

All four laminates were fabricated by vacuum infusion process (VIP). See FIG. 21. The dry reinforcement was hand laid up on a glass table top before sheets of peel ply, resin flow media, and a vacuum bag were placed over the top to create a mold. The vacuum bag was then adhered to the glass table top with tacky tape in order to create the best vacuum seal possible. Spiral resin infusion tubes were then inserted into the mold to act as the resin inlet and outlet gates during laminate fabrication. A vacuum was then pulled to ensure no leaks were present within the mold before infusion. The resin was then initiated, infused, and allowed to cure at room temperature overnight. The panels were then demolded and placed in an oven at 60° C. for 24 hours for post-curing. It was calculated that the unidirectional and woven roving laminates had ˜27 wt % and ˜20 wt % resin, respectively. The TMI-GO concentration within the filled resin laminates were calculated to be 0.01 wt % and 0.008 wt % GO, respectively. Burn off tests of each of the laminates will be conducted to confirm the calculated resin content.

2. Dual Cantilever Beam Specimen Preparation

Testing specimens were machined out from the fabricated panels. Each specimen had dimensions of 5″ length (L) by 1″ width (b) (FIG. 1). The specimens were cut in such a way to have the PTFE insert be 2.5″ long, thus allowing the insert to be an effective pre-crack (a₀) within the laminate. Once the specimens were machined, 1″ wide stainless steel piano hinges were adhered to the surfaces using J-B Weld epoxy. A thin coating of white correction fluid was then painted onto both edges of each specimen to help with crack detection. Black lines were drawn onto the specimen's edge to mark 1 mm intervals. The specimens were tested in an Instron 3369 testing system with a loading rate of 3 mm/min until failure. A magnifying glass was used to help detect crack propagation to ensure the accurate results.

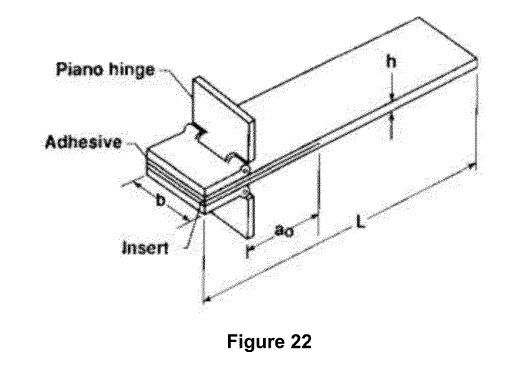

Typically, interlaminar fracture is a predominant cause of composite failure as cracks initiate either in resin rich area or at fiber/resin interface. To assess this for the instant constructs, Interlaminar Fracture Toughness (ILFT)Testing was performed using ASTM D5528. A schematic is presented in FIG. 22. In the test, h=3.2 mm a₀=˜50 mm L=250 mm b=25.5 mm.

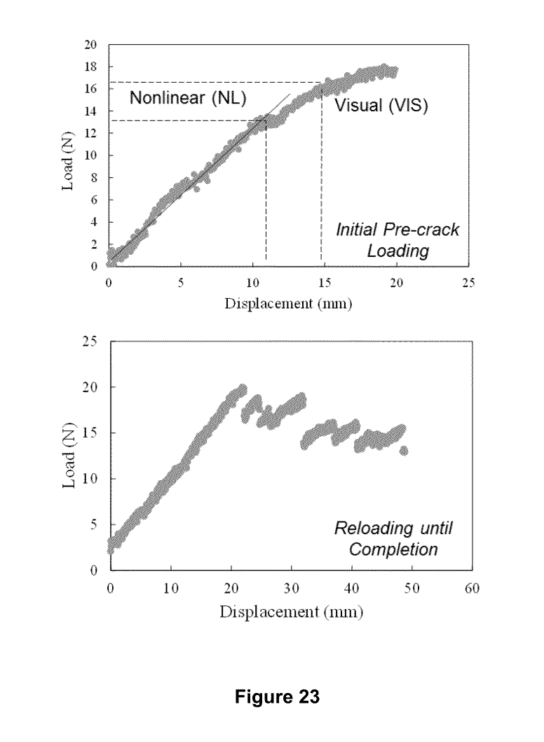

FIG. 23 shows an overview of load versus displacement plots of a filled woven roving laminate. An initial loading was done to form a pre-crack within the laminate (top plot). Two G1C values can be calculated from the initial loading curve: Nonlinear (NL) G1C: point at which crack initiates inside laminate and Visual (VIS) G1C: point at which crack becomes visible on outside edge.

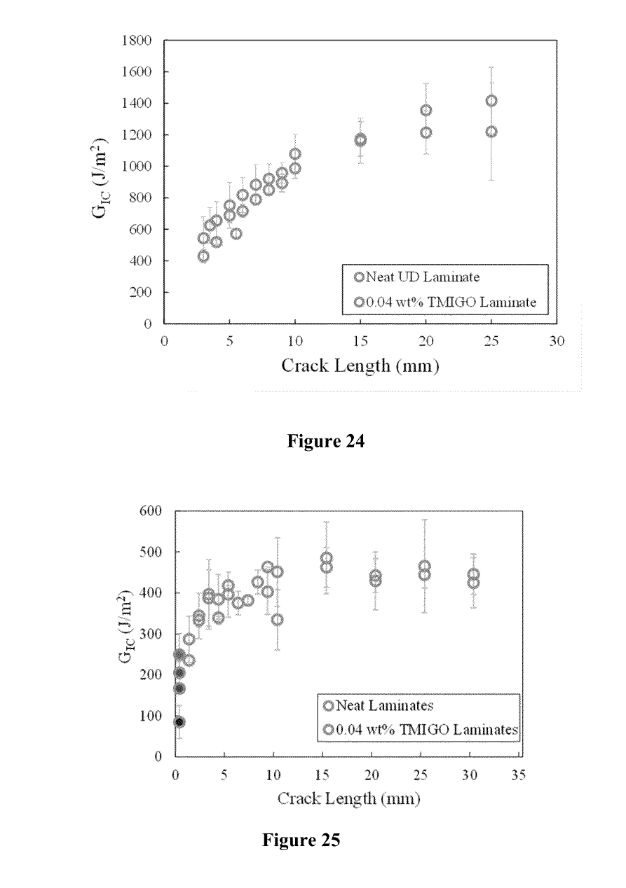

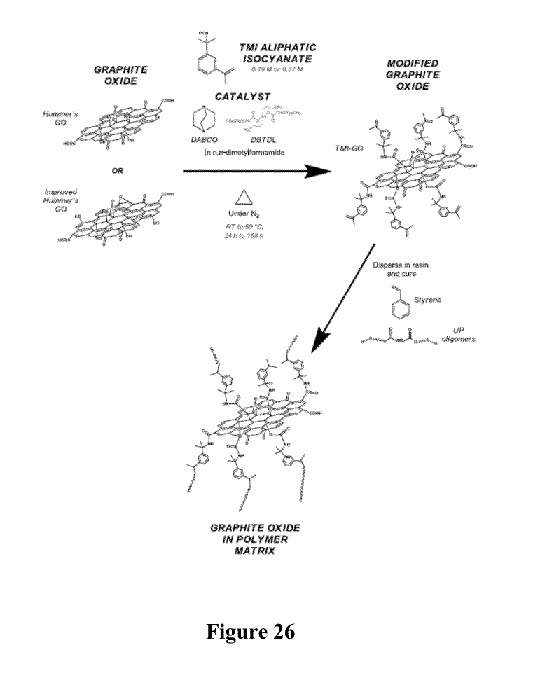

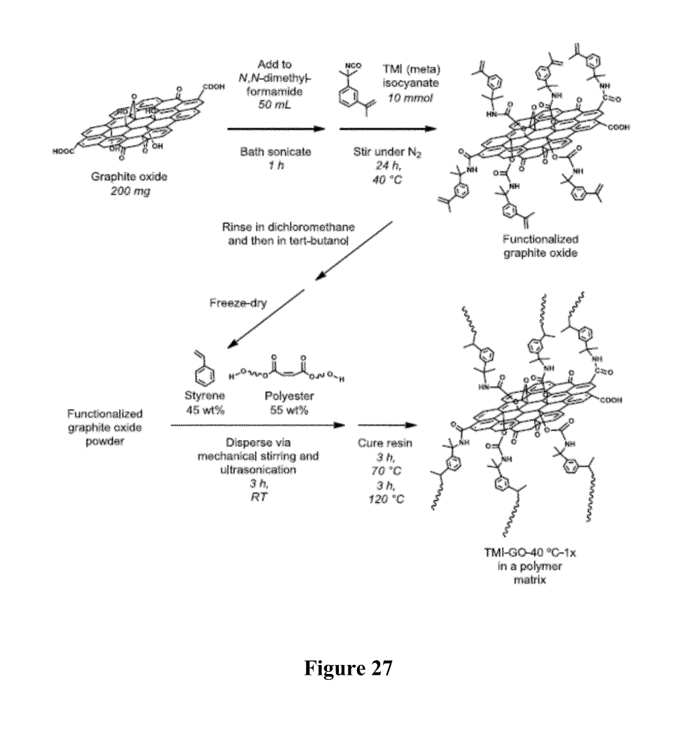

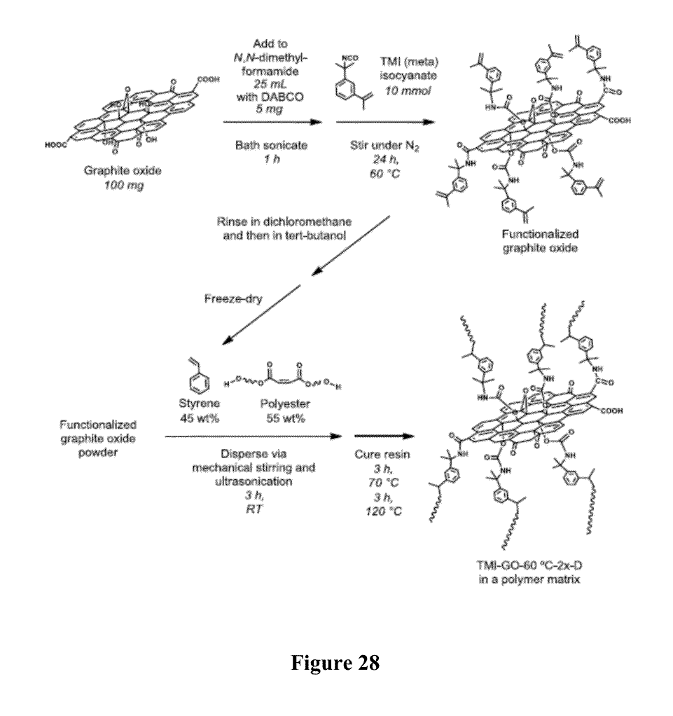

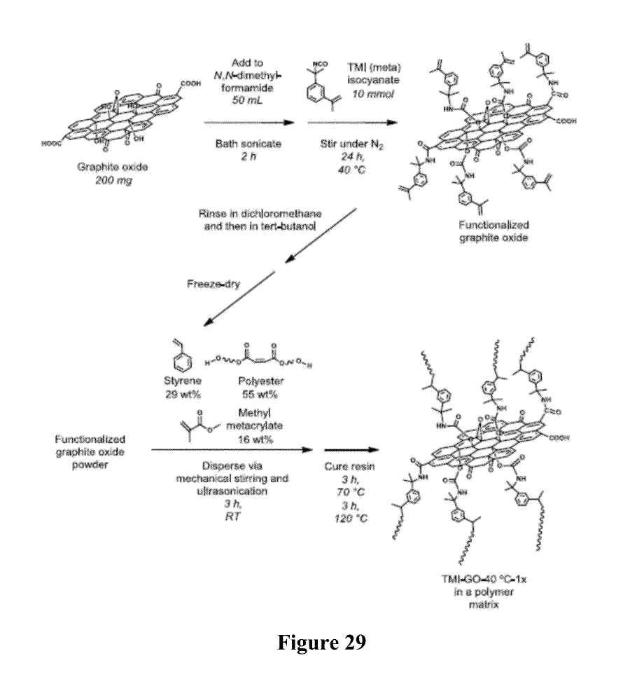

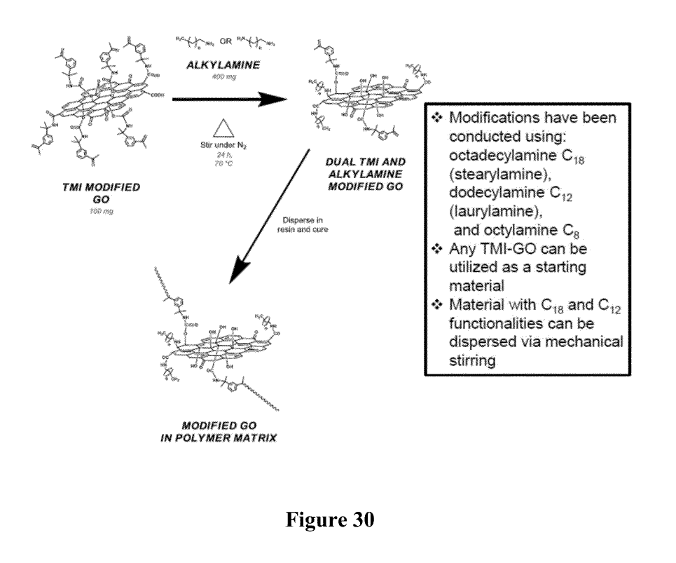

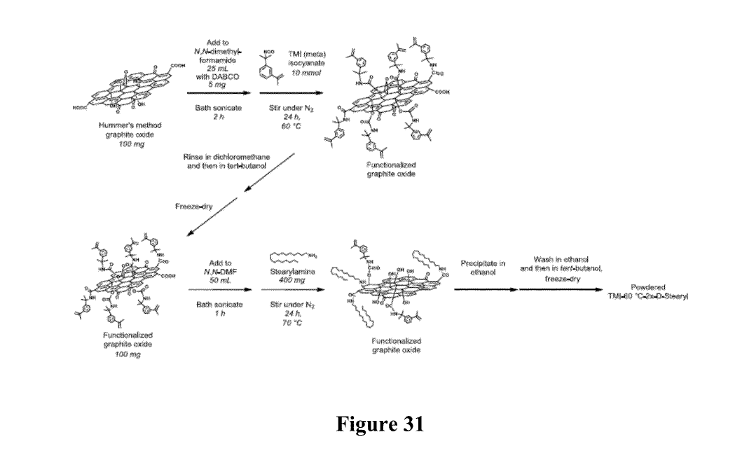

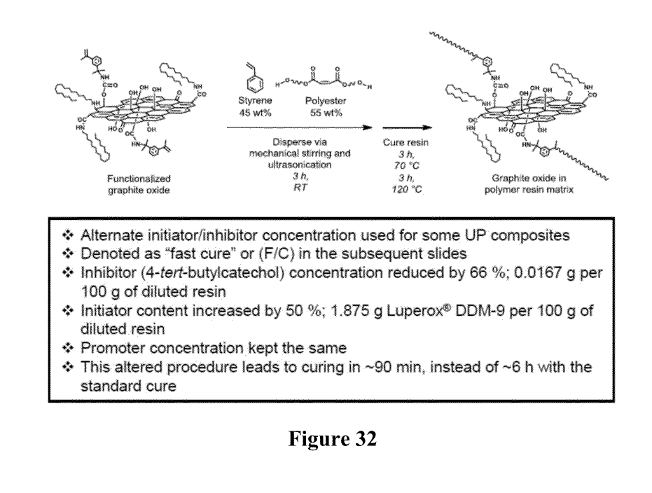

FIG. 24 shows the R-curve of unidirectional glass fiber-reinforced laminates. It is seen here that the laminate filled with 0.04 wt % TMI-GO in the resin had G_{1C} values slightly above the neat resin until a crack propagation length of ˜15 mm. The nonlinear G_{1C} values showed a similar trend as the glass fiber woven roving-reinforced laminates (Table 6), with the filled resin showing a slight increase of only 10% compared to the neat resin. It should be noted that fiber bridging in the neat resin laminate was significantly greater than in the filled resin laminate. Fiber bridging requires higher loads to be applied to the specimen to continue propagating a crack, thus providing higher G_{1C} values than laminates without this effect. By focusing on the G_{1C} values displayed in Table 5 and 6, it can be concluded that the TMI-GO-filled resin laminates can increase the interlaminar fracture toughness of glass fiber-reinforced laminates at very low loadings (≦0.01 wt % TMI-GO in laminate).

TABLE 5

| Woven Roving Laminate | Nonlinear G_{1C} (J/m²) | St. Dev. G_{1C} (J/m²) |
|---|---|---|
| Neat | 90 | ±23 |
| TMIGO-filled | 170 | ±13 |

TABLE 6
Interlaminar fracture toughness values (G_{1C}) of
unidirectional glass fiber-reinforced laminates.

| Unidirectional Laminate | G_{1C} (J/m²) |
|---|---|
| Neat | 570 ± 26 |
| 0.04 wt % TMIGO-filled | 630 ± 113 |

### Example 27

Additional formulations and their mechanical properties are shown in Tables 7-9. Styrene and/or MMA content is shown in the Additional Notes column. Some unsaturated polyester (UP) resins were cured using a process designated “fast cure”. With the fast cure method, inhibitor (4-tert-butylcatechol, for example) concentration reduced by 66%; 0.0167 g per 100 g of diluted resin, initiator content increased by 50% (1.875 g Luperox® DDM-9 per 100 g of diluted resin, for example, and promoter concentration kept the same as for the standard cure. The fast cure process effects a cure in about 90 minutes versus the about 6 hours of the “standard cure.”

In Tables 7-9, the values in ( ) are standard deviations from 5 (σ and E) or 10 (K_{1C} or G_{1C}).

TABLE 7

| | Flexural | Flexural | Fracture | Fracture | |
|---|---|---|---|---|---|
| | Strength, | Modulus, | toughness, | energy, | |
| Samples | σ (MPa) | E (GPa) | K_{IC} (J m⁻²) | G_{IC} (J m⁻²) | Additional Notes |
| Neat AROPOL 8422 | 118 (6) | 3.64 (0.04) | 0.65 (0.03) | 98 (9) | 45 wt % styrene, |
| Plate | | | | | standard cure |
| UP_TMI-GO-40° C.-1x_02 | 112 (6) | 3.61 (0.03) | 0.79 (0.05) | 147 (17) | 45 wt % styrene, |
| Styrene | | | | | standard cure |
| UP_TMI-GO-40° C.-1x_04 | 111 (3) | 3.54 (0.04) | 0.90 (0.05) | 196 (20) | 45 wt % styrene, |
| Styrene | | | | | standard cure |
| UP_TMI-GO-40° C.-1x_08 | 85 (7) | 3.63 (0.22) | 0.81 (0.15) | 159 (54) | 45 wt % styrene, |
| Styrene | | | | | standard cure |
| UP_TMI-GO-40° C.-1x_02 | 116 (6) | 3.75 (0.05) | 0.88 (0.07) | 177 (27) | 29% styrene/16% |
| Styrene + MMA | | | | | MMA, standard cure |
| UP_TMI-GO-40° C.-1x_04 | 100 (5) | 3.94 (0.03) | 1.00 (0.08) | 217 (37) | 29% styrene/16% |
| Styrene + MMA | | | | | MMA, standard cure |
| UP_TMI-GO-40° C.-1x_08 | 96 (3) | 3.93 (0.10) | 1.00 (0.09) | 218 (40) | 29% styrene/16% |
| Styrene + MMA | | | | | MMA, standard cure |
| UP_TMI-GO-60° C.-2x- | 118 (2) | 3.50 (0.02) | 0.80 (0.05) | 154 (18) | 45 wt % styrene, |
| D_02 Styrene | | | | | standard cure |
| UP_TMI-GO-60° C.-2x- | 106 (1) | 3.50 (0.01) | 0.84 (0.07) | 172 (27) | 45 wt % styrene, |
| D_04 Styrene | | | | | standard cure |
| UP_TMI-GO-60° C.-2x- | 96 (3) | 3.51 (0.02) | 0.85 (0.05) | 176 (22) | 45 wt % styrene, |
| D_08 Styrene | | | | | standard cure |

TABLE 8

| | Flexural | Flexural | Fracture | Fracture | |
|---|---|---|---|---|---|
| | Strength, | Modulus, | toughness, | energy, | |
| Samples | σ (MPa) | E (GPa) | K_{IC} (J m⁻²) | G_{IC} (J m⁻²) | Formulation |
| UP_TMI-GO-60° C.-2x- | 115 (4) | 3.50 (0.01) | 0.91 (0.07) | 198 (29) | 45 wt % styrene, |
| Sn_02 Styrene | | | | | standard cure |
| UP_TMI-GO-60° C.-2x- | 90 (19) | 3.75 (0.14) | 0.80 (0.11) | 148 (40) | 45 wt % styrene, |
| Sn_04 Styrene | | | | | standard cure |
| UP_TMI-GO-60° C.-2x- | 123 (3) | 3.65 (0.02) | 0.85 (0.04) | 167 (16) | 45 wt % styrene, |
| Stearyl_02 Styrene | | | | | standard cure |
| UP_TMI-GO-60° C.-2x- | 97 (4) | 3.71 (0.04) | 0.87 (0.09) | 174 (34) | 45 wt % styrene, |
| Stearyl_04 Styrene | | | | | standard cure |
| UP_TMI-GO-60° C.-2x- | 97 (2) | 3.60 (0.02) | 0.96 (0.05) | 219 (25) | 45 wt % styrene, |
| Stearyl_08 Styrene | | | | | standard cure |
| UP_TMI-GO-60° C.-2x- | 105 (4) | 3.70 (0.03) | 0.78 (0.08) | 147 (27) | 45 wt % styrene, |
| Stearyl_04_F/C Styrene* | | | | | fast cure |
| UP_TMI-GO-60° C.-2x- | 102 (4) | 3.59 (0.10) | 0.83 (0.06) | 166 (26) | 45 wt % styrene, |
| Stearyl_08_F/C Styrene* | | | | | fast cure |
| UP_TMI-GO-60° C.-2x- | 107 (7) | 3.83 (0.02) | 0.72 (0.04) | 114 (11) | 45 wt % styrene, |
| Stearyl_15_F/C Styrene* | | | | | fast cure |
| UP_TMI-GO-60° C.-2x- | 96 (5) | 3.92 (0.01) | 0.85 (0.05) | 157 (17) | 45 wt % styrene, |
| Stearyl_20_F/C Styrene* | | | | | fast cure |

TABLE 9

| | Flexural | Flexural | Fracture | Fracture | |
|---|---|---|---|---|---|
| | Strength, | Modulus, | toughness, | energy, | |
| Samples | σ (MPa) | E (GPa) | K_{IC} (J m⁻²) | G_{IC} (J m⁻²) | Formulation |
| UP_TMI-IH-GO-60° C.-2x- | 123 (4) | 3.50 (0.03) | 0.80 (0.04) | 154 (13) | 45 wt % styrene, |
| D_02 Styrene | | | | | standard cure |
| UP_TMI-IH-GO-60° C.-2x- | 109 (9) | 3.51 (0.04) | 0.80 (0.04) | 156 (15) | 45 wt % styrene, |
| D_04 Styrene | | | | | standard cure |
| UP_TMI-IH-GO-60° C.-2x- | 109 (3) | 3.44 (0.04) | 0.74 (0.08) | 137 (30) | 45 wt % styrene, |
| D_08 Styrene | | | | | standard cure |
| UP_GO_02 Styrene | 119 (5) | 3.60 (0.03) | 0.95 (0.04) | 213 (17) | 45 wt % styrene, |
| | | | | | standard cure |
| UP_GO_04 Styrene | 121 (4) | 3.59 (0.02) | 0.83 (0.05) | 161 (18) | 45 wt % styrene, |
| | | | | | standard cure |
| UP_GO_08 Styrene | 98 (10) | 3.61 (0.04) | 0.89 (0.04) | 188 (19) | 45 wt % styrene, |
| | | | | | standard cure |
| UP_GO_15 Styrene | 99 (9) | 3.88 (0.04) | 0.83 (0.05) | 150 (17) | 45 wt % styrene, |
| | | | | | standard cure |
| UP_AND_02 Styrene | 120 (5) | 3.61 (0.03) | 0.79 (0.05) | 146 (18) | 45 wt % styrene, |
| | | | | | standard cure |
| UP_AND_04 Styrene | 119 (5) | 3.57 (0.03) | 0.92 (0.03) | 200 (12) | 45 wt % styrene, |
| | | | | | standard cure |
| UP_AND_08 Styrene | 118 (3) | 3.47 (0.05) | 0.87 (0.09) | 187 (38) | 45 wt % styrene, |
| | | | | | standard cure |

What is claimed:

1. A nanofiller composition comprising:
a nanoparticle;
a plurality of coupling groups bonded to the nanoparticle;
one or more (a) oligomers or (b) organic isocyanate residues bonded to the one or more coupling groups; and, optionally,
one or more dispersing moieties that facilitate dispersion of the nanoparticle bonded to one or more of (i) the coupling groups or (ii) organic isocyanate residues.

2. The nanofiller composition of claim 1, wherein the dispersing moieties comprise C₆-C₁₈ alkyl groups.

3. The nanofiller composition of claim 1, wherein the isocyanate residue is derived from 3-isopropenyl-α,α-dimethylbenzyl isocyanate (TMI) or 4,4′-diphenylmethane diisocyanate (MDI).

4. The nanofiller composition of claim 1, wherein the nanoparticle comprises graphene oxide.

5. The nanofiller composition of claim 1, comprising TMI-GO.

6. The nanofiller composition of claim 1, comprising TMI-GO-Stearyl.

7. The nanofiller composition of claim 1, comprising dual TMI and alkylamine modified GO.

8. The nanofiller composition of claim 1, comprising TMI-GO-Lauryl.

9. The nanofiller composition of claim 1, wherein the one or more coupling groups are covalently bonded to the nanoparticle.

10. The nanofiller composition of claim 1, wherein the one or more coupling groups are ionically bonded to the nanoparticle.

11. The nanofiller composition of claim 1, wherein the coupling group comprises hydroxy, carboxyl, amino, alkenyl, isocyanate, or epoxide.

12. The nanofiller composition of claim 1, wherein the coupling group comprises an organic silane, di-isocyanate, di-amine, or quaternary amine.

13. The nanofiller composition of claim 1, wherein the coupling group is dendritic.

14. The nanofiller composition according to claim 13, wherein the dendritic coupling group comprises a polyamine, polyisocyanate or polyol.

15. The nanofiller composition of claim 1, wherein the average number of repeating units in oligomers attached to the nanoparticle through the one or more coupling groups is in the range of about 2 to about 100.

16. A composite, comprising (i) a polymer matrix and (ii) a nanofiller composition of claim 1.

17. The composite of claim 16, wherein the weight percent of the nanofiller composition based on total weight of the composite is in the range of from about 0.005 wt % to about 1 wt %.

18. The composite according to claim 16, wherein the nanofiller composition is covalently bonded to the polymer matrix.

19. The composite according to claim 16, wherein the nanofiller composition is ionically bonded to the polymer matrix.

20. A method for depositing nanofiller composition of claim 1 in a polymer matrix comprising:
dispersing the nanofiller composition in the polymer matrix, wherein the polymer matrix comprises one or more polymerizable units;
wherein the nanofiller composition improves dispersion, interfacial strength, or both dispersion and interfacial strength between the nanofiller composition and the polymer matrix.

21. The method according to claim 20, wherein dispersing is performed by solvent blending.

22. The method according to claim 20, wherein dispersing is performed by melt compounding.

23. A method for making a composite, comprising:
dispersing a nanofiller composition of claim 1 in a fluid comprising one or more first monomers, the oligomer portion of the oligomer-grafted nanofiller being derived from at least one polymerizable unit corresponding to the one or more second monomers; and
polymerizing the first and second monomers.

24. The method according to claim 23, wherein the polymerizing step is thermally initiated.

25. The method according to claim 23, wherein the polymerizing step is photo-initiated.

26. A composition comprising TMI-GO.

27. A composition comprising TMI-GO-Stearyl.

28. A composition comprising dual TMI and alkylamine modified GO.

29. A composition comprising TMI-GO-Lauryl.

30. A laminate, comprising:
a first layer comprising polymeric matrix comprising polymers derived from a plurality of first polymerizable units and a nanofiller composition, the nanofiller composition comprising:
graphene oxide nanoparticles;
one or more coupling groups bonded to the graphene oxide nanoparticle, and
one or more oligomers bonded to the one or more coupling groups; and
a second layer;
the first and second layers being bonded together.

31. The laminate of claim 30, wherein the nanofiller composition additionally comprises one or more dispersing moieties that facilitate dispersion of the graphene oxide nanoparticle bonded to one or more of the coupling groups.

32. The laminate of claim 31, wherein the dispersing moieties comprise C₆-C₁₈ alkyl groups.

33. The laminate of claim 30, wherein amount of the nanofiller composition in the first layer is in the range of from about 0.005 wt % to about 20 wt % based on the weight of the first layer.

34. The laminate of claim 30, wherein the one or more coupling groups are covalently bonded to the nanoparticle.

35. The laminate of claim 30, wherein the one or more coupling groups are ionically bonded to the nanoparticle.

36. The laminate of claim 30, wherein the coupling group comprises hydroxy, carboxyl, amine, alkene, isocyanate, or epoxide.

37. The laminate of claim 30, wherein the coupling group comprises an organic silane, diisocyanate, diamine, primary amine, secondary amine, tertiary amine, or quaternary amine.

38. The laminate of claim 30, wherein the coupling group is dendritic.

39. The laminate of claim 38, wherein the dendritic coupling group comprises a polyamine, polyisocyanate or polyol.

40. The laminate of claim 30, wherein the polymer of the first layer is a thermoset resin.

41. The laminate of claim 30, wherein the polymer of the first layer is an unsaturated polyester.

42. The laminate of claim 41, wherein the unsaturated polyester is derived from one or more of a diacid component selected from orthophthalic acid and maleic acid and a diol component selected from propylene glycol and ethylene glycol.

43. The laminate of claim 42, wherein the unsaturated polyester additionally comprises styrene residues.

44. The laminate of claim 30, wherein the graphene oxide nanoparticle is GO-vinyl, GO-2-vinyl or GO-vinyl-alkane.

45. The laminate of claim 30, wherein the graphene oxide nanoparticle is TMI-GO, TMI-GO-Stearyl, TMI-GO-Lauryl, and dual TMI and alkylamine modified GO.

46. The laminate of claim 30, wherein the graphene oxide nanoparticle is MDI-GO or MDI-GO modified with a primary or secondary amine or with an alcohol.

47. The laminate of claim 30, wherein the second layer is a polymer film, a woven fiber sheet, a non-woven fiber sheet or metal sheet.

48. The laminate of claim 30, wherein the second layer comprises one or more of fiberglass, carbon fiber, aramid, basalt or metal.

49. The laminate of claim 30, wherein the second layer is a chopped strand mat, continuous strand mat, woven fabric, knitted fabric or stitched fabric.

50. The laminate of claim 30, wherein the second layer comprises a plurality of sub-layers.

51. The laminate of claim 30, wherein the laminate comprises a third layer disposed between the first layer and the second layer.

52. The laminate of claim 51, wherein one or both of the second layer the third layer comprises a plurality of sub-layers.

53. A process for forming a laminate of claim 30, the method comprising utilizing a vacuum infusion process to form the first layer on a substrate comprising the second layer.

54. The process of claim 53, wherein the laminate comprises a third layer disposed between the first layer and the second layer.

55. The process of claim 54, wherein the third layer and the second layer comprise the substrate.

56. The process of claim 53, wherein the polymer of the first layer is an unsaturated polyester.

57. The process of claim 53, wherein the graphene oxide nanoparticle is GO-vinyl, GO-2-vinyl or GO-vinyl-alkane.

58. The process of claim 53, wherein the graphene oxide nanoparticle is TMI-GO, TMI-GO dihexylamine, TMI-GO-Stearyl, TMI-GO-Lauryl, and dual TMI and alkylamine modified GO.

59. The process of claim 53, wherein the graphene oxide nanoparticle is MDI-GO or MDI-GO modified with a primary or secondary amine or with an alcohol.

60. The process of claim 53, wherein the second layer comprises one or more of fiberglass, carbon fiber, aramid, and basalt.

61. The process of claim 53, wherein the second layer is a chopped strand mat, continuous strand mat, woven fabric, knitted fabric or stitched fabric.

62. A process for forming a laminate, comprising:
bonding a first layer to a second layer, wherein
the first layer comprises polymeric matrix comprising polymers derived from a plurality of first polymerizable units and a nanofiller composition, the nanofiller composition comprising: graphene oxide nanoparticles;
one or more coupling groups bonded to the graphene oxide nanoparticle; and
one or more oligomers bonded to the one or more coupling groups.

63. The method of claim 62, wherein the nanofiller composition additionally comprises one or more dispersing moieties that facilitate dispersion of the graphene oxide nanoparticle bonded to one or more of the coupling groups.

64. The method of claim 63, wherein the dispersing moieties comprise C₆-C₁₈ alkyl groups.

65. A pre-laminate layer suitable for bonding to one or more substrates to form a laminate or serving as a pre-preg, comprising:
a polymeric matrix comprising polymers derived from a plurality of first polymerizable units and
a nanofiller composition, the nanofiller composition comprising:
graphene oxide nanoparticles;
one or more coupling groups bonded to the graphene oxide nanoparticle; and
one or more oligomers bonded to the one or more coupling groups.

66. The method of claim 65, wherein the nanofiller composition additionally comprises one or more dispersing moieties that facilitate dispersion of the graphene oxide nanoparticle bonded to one or more of the coupling groups.

67. The method of claim 66, wherein the dispersing moieties comprise C₆-C₁₈ alkyl groups.
